(19) United States
(12) Patent Application Publication
(10) Pub. No.: US 2011/0229668 A1
(43) Pub. Date: Sep. 22, 2011

(54) Modified natural rubber latex and products manufactured from the same

(75) Inventors: William R. Doyle, Duluth, GA (US); Matthew P. Clark, Dacula, GA (US); Travis W. Honeycutt, Gainesville, GA (US)

(73) Assignee: Vystar Corporation, Duluth, GA (US)

(21) Appl. No.: 13/065,205

(22) Filed: Mar. 16, 2011

Related U.S. Application Data
(60) Provisional application No. 61/314,455, filed on Mar. 16, 2010.
(60) Provisional application No. 61/433,853, filed on Jan. 18, 2011.

(51) Int. Cl. C08K 3/22; C08J 9/28; B28B 1/14; B32B 1/00

(52) U.S. Cl. 428/35.5; 524/437; 521/65; 264/299

(57) ABSTRACT

The present disclosure relates to methods of modifying natural rubber latex and products manufactured from same. In an embodiment, an inflatable latex balloon comprises an aluminum hydroxide-modified natural rubber latex envelope. In an embodiment, the aluminum hydroxide-modified natural rubber latex envelope is substantially free of non-rubber impurities. In an embodiment, the aluminum hydroxide-modified natural rubber latex envelope of the balloon, being substantially free of non-rubber impurities, results in tighter rubber particle integration and improved gas retention capabilities. In an embodiment, the aluminum hydroxide-modified natural rubber latex envelope, being substantially free of non-rubber impurities, results in a more stable, cleaner latex requiring less compounding additives for production. In addition, the present disclosure relates to an extruded rubber thread comprising an aluminum hydroxide-modified natural rubber latex. In an embodiment, the aluminum hydroxide-modified natural rubber latex is substantially free of non-rubber impurities.

### RELATED APPLICATIONS

This application claims the benefit of and priority to U.S. Provisional Application Ser. No. 61/314,455, filed Mar. 16, 2010, and U.S. Provisional Application Ser. No. 61/433,853, filed Jan. 18, 2011, the entirety of these applications are hereby incorporated herein by reference.

### FIELD

The embodiments disclosed herein relate to modified natural rubber latex, and more particularly to modified natural rubber latex suitable to make articles supporting, often improving, physical properties, performance characteristics and manufacturing abilities while offering end users health and safety benefits.

### BACKGROUND

Natural rubber was originally derived from milky colloidal suspension, or latex, found in the sap of some plants. Natural rubber latex (NRL) is a cloudy white liquid, similar in appearance to cows milk. The major commercial source of NRL is the Para rubber tree, Hevea brasiliensis. NRL is the basic constituent of many products used in the transportation, industrial, consumer, hygienic and medical sectors due to the mechanical properties of NRL, including, but not limited to, elasticity, resilience, and toughness. Latex in its natural form consists of polymeric, long chain molecules consisting of repeating units of isoprene (rubber particles), proteins like heavamine, hevein, and rubber elongation factor; lysosomal microvacuoles known as lutoids; and double-membrane organelles rich in carotenoids assimilated to plastids, the Frey-Wyssling particles. Although the basic isoprene polymer is non-antigenic, the associated proteins are highly antigenic. Allergy to NRL has become a major source of concern. Problems also exist in NRL processing and the manufacture of latex products due to added chemicals in the processing of NRL.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The presently disclosed embodiments will be further explained with reference to the attached drawings. The drawings shown are not necessarily to scale, with emphasis instead generally being placed upon illustrating the principles of the presently disclosed embodiments.

FIG. 1 shows a schematic illustration of an embodiment of a method of manufacturing aluminum hydroxide-modified natural rubber latex (NRL) of the present disclosure by the removal of proteins and non-rubber impurities through directed application of aluminum hydroxide (Al(OH)₃).

FIG. 2 is a flow chart showing an embodiment of how a method of manufacturing aluminum hydroxide-modified NRL of the present disclosure can be incorporated into a processors manufacturing facility. The complete cycle of production and potential waste recovery and re-use highlights the ecologically friendly nature of the whole production process, and does not require additional capital equipment expenditures.

FIG. 3 is a chart summarizing the overall spray ability of a standard low ammonia NRL compared to an aluminum hydroxide-modified low ammonia (LA) NRL of the present disclosure and an aluminum hydroxide-modified high ammonia (HA) NRL of the present disclosure. The tack of the latex samples was examined, using the rolling ball method.

FIG. 4 is a flow chart showing the production steps for a typical modern glove line.

FIG. 5 is a chart showing protein levels at various steps in the production of gloves made with aluminum hydroxide-modified NRL of the present disclosure or standard NRL using the modified Lowry protein test method. Gloves made with aluminum hydroxide-modified NRL of the present disclosure achieve low protein levels after post dipping while standard NRL requires post off line leaching to achieve low protein levels.

FIG. 6 is a chart showing protein levels at various steps in the production of gloves made with aluminum hydroxide-modified NRL of the present disclosure or standard NRL using the ELISA method. Gloves made with aluminum hydroxide-modified NRL of the present disclosure maintain low protein status at all stages of production, while the standard NRL gloves required off-line post leaching to achieve low protein status.

FIG. 7A and FIG. 7B are photographs showing pigmented uncompounded NRL Films—an aluminum hydroxide-modified NRL CL60 film of the present disclosure (left) produced a whiter and more transparent film sheet compared to common hevea CL60 (right).

FIG. 8A and FIG. 8B are photographs showing a film sheet made from a compounded aluminum hydroxide-modified NRL CL60 of the present disclosure (left) is more transparent and less yellowish compared to common hevea CL60 (right). A balloon made from a compounded aluminum hydroxide-modified NRL CL60 of the present disclosure (left) is whiter compared to a balloon made from common hevea CL60 (right).

FIG. 9A and FIG. 9B are photographs showing a pigmented film sheet made from a compounded aluminum hydroxide-modified NRL of the present disclosure (left) produced some yellowish tone on the blue film sheet. The yellowish tone was not observed on balloon as it is thinner and was properly leached.

FIG. 10A and FIG. 10B are photographs showing a pigmented film sheet made from a compounded aluminum hydroxide-modified NRL of the present disclosure (left). The same yellowish tone on common hevea was observed on the red film sheet as well. In addition, for an aluminum hydroxide-modified NRL the red balloon has more red tone compared to common hevea CL60.

FIG. 11A and FIG. 11B are photographs showing the yellow balloon and the yellow film sheet made from an aluminum hydroxide-modified NRL CL60 of the present disclosure (left) are more yellowish and brighter compared to common hevea CL60 (right) (in which the yellow tone is dull).

FIG. 12A and FIG. 12B are photographs showing that for black pigment visually there was no obvious difference between common hevea CL60 (right) and an aluminum hydroxide-modified NRL CL60 of the present disclosure (left) for both balloons and film sheets.

FIG. 13 is a schematic illustration of a latex vessel depiction, where (R) stands for rubber particles, (L) for lutoids, and (FW) for Frey-Wyssling particles.

FIG. 14 is a graph illustrating the retention of air and helium in balloons produced from an aluminum hydroxide-modified NRL of the present disclosure (noted as “V/Black”) compared to balloons produced from standard NRL (noted as “C/Black”).

FIG. 15 is a graph illustrating tenacity (g/dener) versus % strain curves for aluminum hydroxide-modified NRL threads of the present disclosure compared with an untreated NRL (control) and Spandex.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### SUMMARY

Modified natural rubber latex (NRL) and products manufactured from same are disclosed herein.

According to aspects illustrated herein, there is disclosed an inflatable latex balloon comprising an aluminum hydroxide-modified natural rubber latex envelope. In an embodiment, the aluminum hydroxide-modified natural rubber latex envelope is substantially free of non-rubber impurities. In an embodiment, the aluminum hydroxide-modified natural rubber latex envelope has less than 0.5% non-rubber impurities. In an embodiment, the aluminum hydroxide-modified natural rubber latex envelope is substantially free of non-rubber impurities selected from at least one of Frey-Wyssling particles or lutoids. In an embodiment, the aluminum hydroxide-modified natural rubber latex envelope is substantially free of Frey-Wyssling particles. In an embodiment, the aluminum hydroxide-modified natural rubber latex envelope is substantially free of lutoids. In an embodiment, the aluminum hydroxide-modified natural rubber latex envelope has decreased permeability to inflation gasses such as helium and air as compared with an inflatable latex balloon comprising a natural rubber latex envelope. In an embodiment, the aluminum hydroxide-modified natural rubber latex envelope has increased inflation time to inflation gasses such as helium and air as compared with an inflatable latex balloon comprising a natural rubber latex envelope. In an embodiment, the aluminum hydroxide-modified natural rubber latex envelope has a higher opacity as compared with an inflatable latex balloon comprising a natural rubber latex envelope. In an embodiment, the aluminum hydroxide-modified natural rubber latex is pigmented with a color. In an embodiment, the inflatable latex balloon is for toy applications.

According to aspects illustrated herein, there is disclosed an inflatable latex balloon made by the steps of: subjecting natural rubber latex liquid, prior to its vulcanization, to an amount of aluminum hydroxide sufficient to adsorb non-rubber impurities in the natural rubber latex liquid to the aluminum hydroxide to create a suspension; centrifuging the suspension, wherein the adsorbed non-rubber impurities are separated from the natural rubber latex liquid to result in a supernatant solution of aluminum hydroxide-modified natural rubber latex; removing the supernatant solution of aluminum hydroxide-modified natural rubber latex; and dipping a mold shaped like a deflated balloon into the supernatant solution of aluminum hydroxide-modified natural rubber latex to form the inflatable latex balloon. In an embodiment, the inflatable latex balloon is made by the additional step of, prior to the dipping step, adding a pigment into the supernatant solution of aluminum hydroxide-modified natural rubber latex. In an embodiment, the inflatable latex balloon is made by the additional steps of, after the dipping step, forming a lip on a neck of the balloon; and drying the supernatant solution of aluminum hydroxide-modified natural rubber latex on the mold. In an embodiment, the amount of aluminum hydroxide sufficient to adsorb non-rubber impurities to the aluminum hydroxide is from about 0.01 pounds per hundred pounds of rubber to about 5 pounds per hundred pounds of rubber. In an embodiment, the centrifuging and removing steps are performed more than once.

According to aspects illustrated herein, there is disclosed an extruded rubber thread comprising an aluminum hydroxide-modified natural rubber latex. In an embodiment, the aluminum hydroxide-modified natural rubber latex is substantially free of non-rubber impurities. In an embodiment, the aluminum hydroxide-modified natural rubber latex has less than 0.5% non-rubber impurities. In an embodiment, the aluminum hydroxide-modified natural rubber latex is substantially free of Frey-Wyssling particles. In an embodiment, the aluminum hydroxide-modified natural rubber latex is substantially free of lutoids. In an embodiment, the aluminum hydroxide-modified natural rubber latex has a lower initial tensile modulus as compared with an extruded rubber thread comprising a natural rubber latex. In an embodiment, the aluminum hydroxide-modified natural rubber latex has increased stretch before breaking as compared with an extruded rubber thread comprising a natural rubber latex. In an embodiment, the extruded rubber thread is for textile, medical, scientific, sports and food processing applications.

According to aspects illustrated herein, there is disclosed an extruded rubber thread made by the steps of: subjecting natural rubber latex liquid, prior to its vulcanization, to an amount of aluminum hydroxide sufficient to adsorb non-rubber impurities in the natural rubber latex liquid to the aluminum hydroxide to create a suspension; centrifuging the suspension, wherein the adsorbed non-rubber impurities are separated from the natural rubber latex liquid to result in a supernatant solution of aluminum hydroxide-modified natural rubber latex; removing the supernatant solution of aluminum hydroxide-modified natural rubber latex; streaming the supernatant solution of aluminum hydroxide-modified natural rubber latex through an aperture nozzle or capillary into a bath of coagulant to form a coagulated thread; washing the coagulated thread in a water bath; and drying and heat-curing.

According to aspects illustrated herein, there is disclosed a latex foam article that includes an aluminum hydroxide-modified natural rubber latex. In an embodiment, the aluminum hydroxide-modified natural rubber latex is substantially free of non-rubber impurities. In an embodiment, the aluminum hydroxide-modified natural rubber latex is substantially free of Frey-Wyssling particles. In an embodiment, the aluminum hydroxide-modified natural rubber latex is substantially free of lutoids. In an embodiment, the aluminum hydroxide-modified natural rubber latex has less than 0.5% non-rubber impurities. In an embodiment, the aluminum hydroxide-modified natural rubber latex envelope is substantially free of non-rubber impurities selected from at least one of Frey-Wyssling particles or lutoids. In an embodiment, the aluminum hydroxide-modified natural rubber latex has decreased odor as compared with a latex foam article comprising natural rubber latex.

According to aspects illustrated herein, there is disclosed a latex foam article made by the steps of: subjecting natural rubber latex liquid, prior to its vulcanization, to an amount of aluminum hydroxide sufficient to adsorb non-rubber impurities in the natural rubber latex liquid to the aluminum hydroxide to create a suspension; centrifuging the suspension, wherein the adsorbed non-rubber impurities are separated from the natural rubber latex liquid to result in a supernatant solution of aluminum hydroxide-modified natural rubber latex; removing the supernatant solution of aluminum hydroxide-modified natural rubber latex; pouring the supernatant solution of aluminum hydroxide-modified natural rubber latex into a mattress mold. In an embodiment, a Dunlop process is used to manufacture a latex foam mattress of the present disclosure. In an embodiment, a Talalay process is used to manufacture a latex foam mattress of the present disclosure.

### DETAILED DESCRIPTION

The present disclosure may be understood more readily by reference to the following detailed description of preferred embodiments and the Examples included therein and their previous and following description. It is also to be understood that the terminology used herein is for the purpose of describing particular embodiments only and is not intended to be limiting.

In an embodiment, the present disclosure relates to an inflatable latex balloon comprising an aluminum hydroxide-modified natural rubber latex envelope. In an embodiment, the present disclosure relates to an inflatable latex balloon comprising an aluminum hydroxide-modified natural rubber latex envelope, wherein the aluminum hydroxide-modified natural rubber latex envelope is substantially free of non-rubber impurities selected from at least one of Frey-Wyssling particles or lutoids, and wherein the aluminum hydroxide-modified natural rubber latex envelope has decreased permeability to inflation gasses such as helium and air as compared with an inflatable latex balloon comprising unmodified natural rubber latex envelope. In an embodiment, the present disclosure relates to an extruded rubber thread comprising an aluminum hydroxide-modified natural rubber latex. In an embodiment, the present disclosure relates to an extruded rubber thread comprising an aluminum hydroxide-modified natural rubber latex, wherein the aluminum hydroxide-modified natural rubber latex is substantially free of non-rubber impurities selected from at least one of Frey-Wyssling particles or lutoids, and wherein the aluminum hydroxide-modified natural rubber latex has increased stretch before breaking as compared with an extruded rubber thread comprising unmodified natural rubber latex. In an embodiment, the present disclosure relates to a latex foam article that includes an aluminum hydroxide-modified natural rubber latex. In an embodiment, the present disclosure relates to a latex foam article that includes an aluminum hydroxide-modified natural rubber latex, wherein the aluminum hydroxide-modified natural rubber latex is substantially free of non-rubber impurities selected from at least one of Frey-Wyssling particles or lutoids, and wherein the aluminum hydroxide-modified natural rubber latex has decreased odor as compared with a latex foam article comprising unmodified natural rubber latex.

It must be noted that, as used in the specification and the appended claims, the singular forms “a,” “an” and “the” include plural referents unless the context clearly dictates otherwise. Thus, for example, reference to “a natural latex composition” includes mixtures of natural latex compositions.

Often, ranges are expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

A weight percent of a component, unless specifically stated to the contrary, is based on the total weight of the formulation or composition in which the component is included.

“Optional” or “optionally” means that the subsequently described event or circumstance may or may not occur, and that the description includes instances where said event or circumstance occurs and instances where it does not. For example, the phrase “optionally present” means that the substance at reference may or may not be present, and that the description includes instance wherein the substance is and is not present.

As used herein, “pounds per hundred rubber” or “PHR” means the proportion of a component per 100 pounds of elastomer.

As used herein, the terms “treated NRL,” “aluminum hydroxide-modified NRL,” “modified NRL,” and “reduced allergenicity NRL” are intended to refer to a NRL composition that has been treated in accordance with the various methods of the presently disclosed embodiments.

As used herein, “Lowry” is intended to refer to a Modified Lowry test methodology (ASTM D5712-05) or data derived therefrom for the analysis of protein in NRL and is recognized by the FDA for determination of total aqueous protein levels in any latex device regulated by the FDA. The Lowry test involves the reaction of latex proteins with an alkaline copper tartrate compound and the subsequent reaction of the protein-copper tartrate complex with Folin reagent, resulting in a blue color read using a spectrophotometer at 700 nm. The Lowry test is subject to interference by chemical accelerators, such as carbamates, thiurams, benzothiazoles and guanidines, used in the production of latex dipped products (e.g., gloves, condoms, etc.) and phenolic chemicals naturally found in latex. In an embodiment, an aluminum hydroxide-modified NRL of the present disclosure comprises less than 28 μg of total protein per gram of NRL.

As used herein, “ELISA” is intended to refer to the ELISA Inhibition Assay test methodology (ASTM-D6499-07) or data derived therefrom. The ELISA inhibition test measures the antigenic proteins in NRL by using latex-specific antibodies collected from hyperimmunized rabbits. This immunochemical method is much more sensitive than the Lowry test. The FDA recognizes this standard as a measurement of the antigenic proteins in the finished latex product for most, but not all, devices regulated by the FDA. The ELISA test is designed and performed to quantify the antigenic NRL proteins in an ammoniated state. NRL film extracts, prepared in accordance with the methods of the present disclosure, consistently yield low total protein and antigenic protein content using both of these ASTM methods, however reproducibility issues and divergent values were commonly observed in the ELISA test method due to protein modification and test limitations.

As used herein, the term “antigenic protein,” refers to a protein that can induce the generation of antibodies and can cause an immune response in a subject who comes in contact with the antigenic protein.

As used herein, the term “non-rubber impurities” refers to lysosomal microvacuoles known as lutoids, and double-membrane organelles rich in carotenoids assimilated to plastids, the Frey-Wyssling particles, found in natural rubber latex. In an embodiment, the methods disclosed herein result in an aluminum hydroxide-modified natural rubber latex substantially devoid of non-rubber impurities. In an embodiment, the methods disclosed herein result in an aluminum hydroxide-modified natural rubber latex with substantially all non-rubber impurities removed. In an embodiment, the methods disclosed herein result in an aluminum hydroxide-modified natural rubber latex having less than 1.2% non-rubber impurities. In an embodiment, the methods disclosed herein result in an aluminum hydroxide-modified natural rubber latex having less than 1.0% non-rubber impurities. In an embodiment, the methods disclosed herein result in an aluminum hydroxide-modified natural rubber latex having less than 0.5% non-rubber impurities.

NRL is the basic constituent of many products used in the transportation, industrial, consumer, hygienic and medical sectors due to the complex mechanical properties of NRL, including, but not limited to, elasticity, resilience, tactile sensitivity and toughness. The availability, ease of production, and performance of latex products make NRL a preferred raw material by product manufacturers and users around the globe. NRL's proven “green biodegradable behavior” makes NRL the material of choice in an increasingly environmentally conscious society. Manufacturers have utilized low-protein latices combined with improved leaching processes in an attempt to offer consumers safer latex products.

In an embodiment, a method of manufacturing an aluminum hydroxide-modified NRL of the present disclosure includes subjecting NRL, prior to vulcanization, to aluminum hydroxide so as to reduce protein levels in the latex rubber. In an embodiment, the method removes specific non-rubber impurities from natural rubber latex (NRL) through directed application of aluminum hydroxide (Al(OH)₃). Aluminum hydroxide is used in the process of water purification and acts as an absorbent, emulsifier, ion-exchanger, and antacid. Aluminum hydroxide forms a jelly-like structure suspending any unwanted materials in water, including bacteria.

In an embodiment, the processing steps of the present disclosure can be integrated into existing latex manufacturing lines without the need for additional capital equipment. For example, in an embodiment, a slurry of insoluble aluminum hydroxide can be added to field latex. In such an embodiment, proteins and other non-rubber impurities present in the field latex can be exchanged with and/or complexed with insoluble aluminum hydroxide Al(OH)₃. Al(OH)₃ has a very unique and reactive surface area. In an embodiment, at least a portion of the proteins and/or impurities can be adsorbed on a reactive surface of aluminum hydroxide crystals from the slurry. Adsorption relies primarily on electrostatic forces and electron sharing between the proteins and the aluminum hydroxide. Adsorption of proteins onto aluminum hydroxide is dependent on the physical and chemical characteristic of the proteins as well as the conditions of adsorption, such as pH, temperature, and particle size.

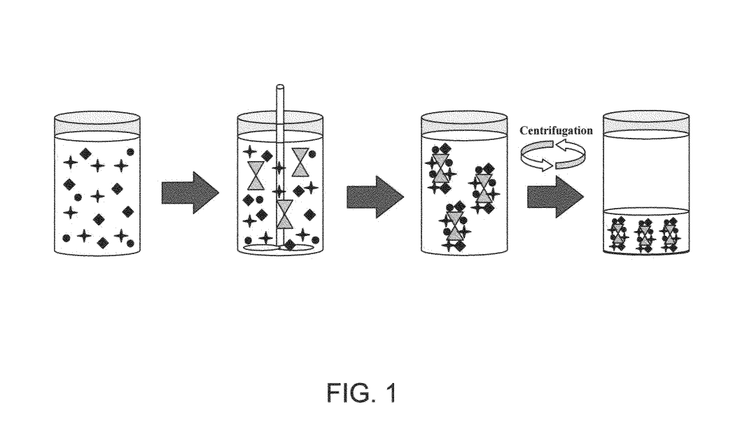

An exemplary process for the manufacture of aluminum hydroxide-modified NRL is illustrated in the schematic illustration of FIG. 1. In FIG. 1, sap from a rubber tree, comprising proteins (designated as [symbol] ), Frey-Wyssling particles (designated as *), lutoids (designated as *), or a combination thereof, are presented. Aluminum hydroxide (designated as [symbol] ) is added to the sap to form a slurry, wherein, in an embodiment, the impurities can be adsorbed onto the surface of aluminum hydroxide particles within the slurry. The slurry is centrifuged and the adsorbed non-rubber impurities and proteins are separated from the natural rubber latex liquid to result in a supernatant solution of aluminum hydroxide-modified natural rubber latex. Adsorption can be dependent on the physical and chemical characteristic or the protein as well as the conditions of adsorption, such as pH, temperature, and particle size.

In an embodiment, the process for the manufacture of an aluminum hydroxide-modified NRL of the present disclosure includes mixing 0.01-1 pounds per hundred pounds of rubber (phr) of aluminum hydroxide of a particular micron size with 0.1-2 phr of 10% ammonium hydroxide and 0.01-1 phr of surfactant. The mixture of aluminum hydroxide, and surfactant is added to the field latex, and mixed under agitation. In an embodiment, the latex is maturated for 21 days prior to commercial use. In an embodiment, the process for the manufacture of an aluminum Hydroxide-modified NRL can be single centrifuged, double centrifuged, clarified or other process for removing the aluminum hydroxide complexes.

The individual concentrations of latex and aluminum hydroxide needed to produce an aluminum hydroxide-modified NRL can vary depending upon the process parameters and the desired properties of the resulting product. The individual concentrations of latex and aluminum hydroxide can also vary depending on variations of, for example, protein levels in the raw materials. In an embodiment, the present disclosure comprises any amount of latex combined with any amount of aluminum hydroxide and is not intended to be limited to any particular concentration range of one or more components. In various exemplary embodiments, latex comprises from about 27% of total solids to about 30% of total solids, and aluminum hydroxide comprises from about 0.01 phr to about 5 phr, for example, about 0.01, 0.02, 0.04, 0.06, 0.08, 0.1, 0.2, 0.3, 0.4, 0.5, 0.6, 0.7, 0.8, 0.9, 1, 1.2, 1.4, 1.6, 1.8, 2, 2.5, 3, 3.5, 4, 4.5, or 5 phr, or from about 0.1 phr to about 1 phr, for example, about 0.1, 0.2, 0.3, 0.4, 0.5, 0.6, 0.7, 0.8, 0.9, or 1 phr. In an embodiment, at least about 0.1 phr aluminum hydroxide is admixed with NRL. In an embodiment, about 0.4 phr aluminum hydroxide is admixed with NRL. In an embodiment, about 1 phr aluminum hydroxide is admixed with NRL.

The average particle size and distribution, the chemical purity, and/or the density of a particular aluminum hydroxide can vary depending upon the specific process parameters and/or the requirements of the desired final latex article from about 1 to about 100 micrometers.

The aluminum hydroxide of the present disclosure can be contacted with NRL at any time prior to vulcanization. NRL can be centrifuged to concentrate the composition with the added benefit of purifying the material by removal of a portion of water soluble protein material comprised therein. It should be noted that centrifuging alone without addition of aluminum hydroxide will not typically provide the low level of antigenic protein attainable in aluminum hydroxide treated NRL or centrifuged aluminum hydroxide treated NRL. In an embodiment of the present disclosure, the NRL is not centrifuged. In an embodiment, the NRL is centrifuged to remove at least a portion of the protein material comprised therein. If NRL is centrifuged, aluminum hydroxide can be added prior to or subsequent to centrifugation. In an embodiment, aluminum hydroxide is contacted with NRL prior to centrifuging, and the resulting mixture is then centrifuged.

In an embodiment, the aluminum hydroxide can be admixed with NRL for any period of time, such as, for example, from about less than an hour to 72 hours, for example, about 0.5, 1, 2, 3, 4, 5, 8, 10, 12, 15, 20, 22, 24, 26, 28, 30, 36, 40, 45, 50, 55, 60, 65, 70 or 72 hours. While not wishing to be bound by theory, it is believed that contacting NRL with aluminum hydroxide modifies at least a portion of the antigenic protein within the NRL.

It should be noted that other components, such as, for example, fillers, additives, rheological and/or processing aids can be added to the NRL composition before, simultaneous with, and/or after addition of the aluminum hydroxide.

In various embodiments, one or more surfactants can be mixed with NRL. A surfactant, if used, can be contacted with and/or mixed with NRL at any time prior to vulcanization. In an embodiment, a surfactant is mixed with NRL and aluminum hydroxide prior to the optional removal of the aluminum hydroxide. Addition of a surfactant can, in various aspects, facilitate the association and/or removal of both hydrophobic and hydrophilic proteins from NRL. In addition, a surfactant, if used, can, in various embodiments, result in facile removal of proteins from the NRL by a subsequent leaching, extraction step, filtration, and/or centrifugation step. A surfactant, if used, can be any surfactant suitable for use in NRL. In various embodiments, a surfactant can comprise an anionic surfactant, a cationic surfactant, a non-ionic surfactant, or a combination thereof. In an embodiment, a surfactant is added to a latex composition comprising aluminum hydroxide. In an embodiment, a surfactant is added to a latex composition with aluminum hydroxide, wherein the latex composition is subsequently centrifuged. In an embodiment, no surfactant is added to a latex composition. Further, a surfactant, if used, can be added or contacted in any concentration suitable for use in a given process and/or for producing a desired latex article.

The combination of an aluminum hydroxide/surfactant treatment can, in various embodiments, result in significantly improved removal of protein from the NRL. The addition of an optional surfactant can facilitate liberation of proteins absorbed onto latex particles. In such a treatment, the liberated, for example, hydrolyzed, proteins can associate with and/or bind to the aluminum hydroxide present in the solution. At near neutral pH values, aluminum hydroxide is not substantially water soluble and can be removed via centrifugation, as described above. The use of a surfactant can provide additional benefits upon aging of a latex solution and/or article. In an embodiment, proteins present in a latex composition that has not been treated with a surfactant can remain absorbed onto latex particles and can be subsequently released upon aging. In various embodiments, NRL not treated with aluminum hydroxide can have an antigenic protein value of from about 32% to about 96% higher than a composition treated with aluminum hydroxide and surfactant after 21 days storage. While the specific improvement of a composition can vary depending on, for example, the properties of the feedstock material, it should be appreciated that the addition of a surfactant to a treatment process can result in reduced antigenic protein levels, even after storage, and thus, improved stability of the resulting latex solution or article.

Once the admixture of NRL and aluminum hydroxide is contacted and optionally agitated, thus complexing and/or modifying at least a portion of the antigenic protein, the treated latex comprising modified protein can be vulcanized to produce a latex article. In an embodiment, a vulcanizing step can be performed without substantially disrupting the physical and/or chemical benefits brought by the aluminum hydroxide treated NRL.

After treatment with aluminum hydroxide, the reacted and/or complexed aluminum hydroxide and any antigenic protein that has associated with and/or bound to the aluminum hydroxide can optionally be removed. In an embodiment, at least a portion of the aluminum hydroxide is removed from the NRL composition after contacting and agitation. In another embodiment, substantially all of the aluminum hydroxide is removed from the NRL composition after contacting and agitation. Removal of aluminum hydroxide from a treated NRL composition can be performed by any suitable technique. In various embodiments, removal of aluminum hydroxide can be performed by filtration techniques, centrifugation, or a combination thereof. In an embodiment, at least a portion of the aluminum hydroxide can be removed by centrifugation or by use of a clarifying process. In an embodiment, at least a portion of the aluminum hydroxide can be removed by filtration. In an embodiment, at least a portion of the aluminum hydroxide can be removed by a combination of filtration, centrifugation, stabilizers, anti-oxidants, and optionally other methods such as clarification. Treated NRL can also be subjected to a treatment step comprising exposure to hot water and/or chlorine or a chlorine comprising solution, such as, for example, chlorine comprising solutions commonly utilized in latex manufacturing processes.

In an embodiment, if at least a portion of the reacted and/or complexed aluminum hydroxide is removed, the remaining rubber particles can retain the surrounding lipid layer. In such an embodiment, the lipid layer can provide improved mechanical stability of the latex during maturation as higher fatty acids (HFA) are formed.

After the optional removal of aluminum hydroxide from NRL, the resulting latex can exhibit improved optical properties, such as, for example, improved clarity and/or appearance, reduced color, reduced odor, and/or increased translucency without adversely affecting the desirable properties of natural rubber latex. The treated NRL can also, in various aspects, exhibit improved stability, gel time, and gas retention as compared to untreated NRL compositions.

In an embodiment, and not wishing to be bound by theory, the improved clarity and appearance of an aluminum hydroxide-modified NRL of the present disclosure is due, in part, to the removal of proteins, lipids, lutoids, and Frey-Wyssling particles that can be present in freshly tapped latex. The carotenoid pigments of Frey-Wyssling particles are believed to contribute to the yellow appearance of traditional latex materials. The presence of these impurities (e.g., proteins, lipids, lutoids, and Frey-Wyssling particles) in untreated NRL can result in faster hydration of the untreated NRL than an aluminum hydroxide-modified NRL of the present disclosure, possibly compromising the dielectric properties of an article formed from the untreated NRL. In an embodiment, an aluminum hydroxide-modified NRL of the present disclosure has up to 75% fewer non-rubber components than traditional natural rubber latex. In an embodiment, an aluminum hydroxide-modified NRL of the present disclosure has up to 95% fewer non-rubber components than traditional natural rubber latex.

In an embodiment, films prepared from untreated NRL, when dried and cured, exhibit a semi-transparent yellow color. Traditionally, whitening agents, such as titanium dioxide, calcium carbonate, and/or other pigmenting agents are added to NRL. The use of such pigments can be expensive and incorporation of pigments into NRL can be time and energy intensive. In contrast, an aluminum hydroxide-modified NRL of the present disclosure can, in various aspects, exhibit a lighter, more translucent color, reducing and/or eliminating the need for additional whitening agents or pigments. In an embodiment, an aluminum hydroxide-modified NRL of the present disclosure can require the use of no additives, such as, for example, pigments, stabilizers and whitening agents. In an embodiment, an aluminum hydroxide-modified NRL of the present disclosure can require the use of substantially less additives, such as, for example, pigments, stabilizers and whitening agents, than untreated NRL.

In an embodiment, a portion of, substantially all of, or all of the aluminum hydroxide can remain in an aluminum hydroxide-modified NRL of the present disclosure. In an embodiment, an excess of aluminum hydroxide can be used and/or additional aluminum hydroxide added to the NRL such that a residual amount of aluminum hydroxide remains, for example, suspended in a liquid latex solution. Such an amount of aluminum hydroxide can be added prior to, simultaneous to, or subsequent to the addition of any other amounts of aluminum hydroxide, and/or optionally after removal of at least a portion of any earlier added aluminum hydroxide that can be complexed to protein. Residual aluminum hydroxide can be useful in various aspects due to the fact that some protein that is covalently bonded to a rubber particle can persist, but in the continued presence of an alkali pH, and in some aspects, especially when compounded, the backbone of such a protein can break and the protein/peptide subsequently go into the aqueous phase of the composition. In an embodiment, any aluminum hydroxide remaining in a composition can act as a scavenger for impurities and/or proteins. Thus, the presence of aluminum hydroxide can, in various aspects, complex proteins, creating an insoluble precipitate known as an organic lake.

Further, while not wishing to be bound by theory, it is hypothesized that as water is removed during production of a latex article, a salt of the protein and aluminum hydroxide can be formed that displaces water as a byproduct. Once such a salt is formed, the protein will have no available reactive sites. Such a protein can remain present in the composition or produced article as part of a neutral and non-reactive molecule, without resulting in allergenicity.

With processing steps integrated into the manufacturing stages, there is no expense of capital equipment required. In an embodiment, reacted Al(OH)₃ complexes are removed by a combination of filtration and centrifugation. In an embodiment, the remaining rubber particles retain the surrounding lipid layer, which during subsequent maturation improves the mechanical stability of the latex as the higher fatty acids (HFA) are formed. Notably, it has been observed that this process yields products exhibiting greater clarity and significantly reduced odor, in addition to low antigenic protein without sacrificing the properties that give NRL its enormous advantages over synthetic alternatives. Earlier industry efforts have produced low antigenic source latex through the treatment of raw latex with enzymes. Products made with the aluminum hydroxide-treated source material will demonstrate either parity or superiority compared to products made with non-treated NRL source materials exhibiting relatively easy integration characteristics. In an embodiment, an aluminum hydroxide-modified NRL of the present disclosure offers enhanced performance characteristics for certain applications believed to be due to the non-rubber impurity removal process. The benefits of an aluminum hydroxide-modified NRL of the present disclosure include, but are not limited to, color, stability, gel time, and air retention.

An aluminum hydroxide-modified NRL of the present disclosure formed by the methods described herein can provide reduced allergenicity over traditional latex rubber products and can be suitable for use in a variety of applications. While not intending to be limited, applications for products produced from aluminum hydroxide-modified NRL can include medical, health care, personal care and industrial products, such as, for example, examination and surgical gloves, condoms, breather bags, latex tubing, probe covers, and catheters, along with other applications such as threads, foams, cold seal and pressure sensitive adhesives, industrial gloves and balloons. In an embodiment, an aluminum hydroxide-modified NRL composition formed by the methods described herein is a highly purified latex with ultra low levels of total and antigenic proteins and having improved performance characteristics over traditional natural rubber latex or synthetic substitutes. In an embodiment, an aluminum hydroxide-modified NRL composition of the present disclosure meets ASTM Standard D1076 (Rubber Standards) DOI: 10.1520/D1076-10 Category 5 for a centrifuged Hevea latex comprising less than 0.5% non-rubber impurities.

Products produced from an aluminum hydroxide-modified NRL of the present disclosure can demonstrate excellent resistance to aging compared to untreated NRL (e.g., Hevea) samples. In an embodiment, and while not wishing to be bound by theory, the use of aluminum hydroxide can bind and/or remove antigenic protein from a latex composition and can also assist in the removal of species vulnerable to free radical breakdown. Removal of such species can prevent, reduce, and/or delay degradation of rubber articles produced form NRL. For example, the presence and/or contacting of aluminum hydroxide with NRL can provide increased stability of freshly harvested latex. The aluminum hydroxide treatment can thus be used as a partial and/or complete replacement for surfactants. In an embodiment, NRL is treated with aluminum hydroxide and is not treated and/or contacted with a surfactant. In an embodiment, NRL is treated with aluminum hydroxide and is treated and/or contacted with a surfactant. The combination of aluminum hydroxide and surfactant treatment and/or surfactant contacting with NRL can, in various embodiments, provide enhanced stability and protein removal.

Film samples and products made from a NRL treated in accordance with the methods of the present disclosure can provide a significant reduction in protein levels over products prepared using traditional methods. Film samples and products made from a NRL treated in accordance with the methods of the present disclosure can provide a significant reduction in non-rubber impurities over products prepared using traditional methods.

A treated NRL composition, such as, for example, a liquid latex composition, a cast uncured film, or a cast film can have any level of antigenic protein present that is suitable for an intended application. As tolerances for antigenic proteins can vary depending upon the intended application, method of use, and human factors, the target level of antigenic protein in a treated NRL composition can also vary and the present disclosure is not intended to be limited to a treated NRL composition having any particular antigenic protein level. In an embodiment, a treated NRL composition is free of or substantially free of antigenic protein. In an embodiment, a treated NRL composition can have less than about 100 μg, less than about 50 μg, less than about 30 μg, less than about 20 μg, less than about 10 μg, less than about 5 μg, less than about 2 μg, less than about 1 μg or less than about 0.2 μg of antigenic protein per gram of composition. In an embodiment, a treated NRL composition comprises less than about 5 μg of antigenic protein per gram of composition. In an embodiment, a treated NRL composition comprises less than about 2 μg of antigenic protein per gram of composition. In an embodiment, a treated NRL composition comprises less than about 1 μg of antigenic protein per gram of composition. In an embodiment, a treated NRL composition comprises less than about 0.5 μg of antigenic protein per gram of composition.

In an embodiment, a cast, uncured latex film composition comprises less than about 100 μg, less than about 50 μg, less than about 30 μg, less than about 20 μg of antigenic protein per gram of composition. In an embodiment, a cast, uncured latex film composition comprises less than about 20 μg of antigenic protein per gram of composition. In an embodiment, a cast, uncured latex film comprises less than about 100 μg, less than about 50 μg, less than about 30 μg, less than about 20 μg, less than about 10 μg, less than about 5 μg, less than about 2 μg, less than about 1 μg or less than about 0.2 μg of antigenic protein per gram of composition. In an embodiment, the latex portion of a liquid latex composition, film, or other latex comprising composition comprises less than about 100 μg, less than about 50 μg, less than about 30 μg, less than about 20 μg, less than about 10 μg, less than about 5 μg, less than about 2 μg, less than about 1 μg or less than about 0.2 μg of antigenic protein per gram of composition. In an embodiment, the elastomeric portion of a liquid latex composition, film, or other latex comprising composition comprises less than about 100 μg, less than about 50 μg, less than about 30 μg, less than about 20 μg, less than about 10 μg, less than about 5 μg, less than about 2 μg, less than about 1 μg or less than about 0.2 μg of antigenic protein per gram of composition. Thus, for example, if an article formed from a latex composition comprises a filler material or other non-elastomeric component, the elastomeric portion of the article can comprise less than about 100 μg, less than about 50 μg, less than about 30 μg, less than about 20 μg, less than about 10 μg, less than about 5 μg, less than about 2 μg, less than about 1 μg or less than about 0.2 μg of antigenic protein per gram of the elastomeric portion of the article. In an embodiment, a liquid latex composition comprises non-detectable levels of antigenic protein per ASTM D6499-07 ELISA method.

In an embodiment, a treated NRL composition can have less than about 100 μg/dm², less than about 50 μg/dm², less than about 30 μg/dm², less than about 20 μg/dm², less than about 10 μg/dm², less than about 5 μg/dm², less than about 2 μg/dm², less than about 1 μg/dm² or less than about 0.5 μg/dm² of antigenic protein. In an embodiment, the latex portion and/or elastomeric portion of a treated NRL composition has less than about 100 μg/dm², less than about 50 μg/dm², less than about 30 μg/dm², less than about 20 μg/dm², less than about 10 μg/dm², less than about 5 μg/dm², less than about 2 μg/dm², less than about 1 μg/dm² or less than about 0.5 μg/dm² of antigenic protein.

In an embodiment, the reduction in antigenic protein concentration in a treated NRL composition can be range from about 50% to about 99.9%, for example, about 50, 55, 60, 65, 70, 75, 80, 85, 90, 95, 97, 98, 99, 99.5, or 99.9%; from about 75 to about 99%, for example, about 75, 77, 79, 81, 83, 85, 87, 89, 91, 93, 95, 97, or 99%; from about 85 to about 99%, for example, about 85, 86, 87, 88, 89, 90, 91, 92, 93, 94, 95, 96, 97, 98, or 99%. In an embodiment, the reduction in antigenic protein concentration in a treated NRL composition can vary and can be less than about 50% or greater than about 99.9%, and the present disclosure is not intended to be limited to any particular reduction in antigenic protein concentration. In an embodiment, any of the concentrations and/or percentage reductions recited herein with respect to antigenic protein levels can be based on a liquid composition, a film, and/or a finished latex article. In an embodiment, any of the concentrations and/or percentage reductions recited herein with respect to antigenic protein levels can be based on the latex component of a liquid composition, a film, and/or a finished article.

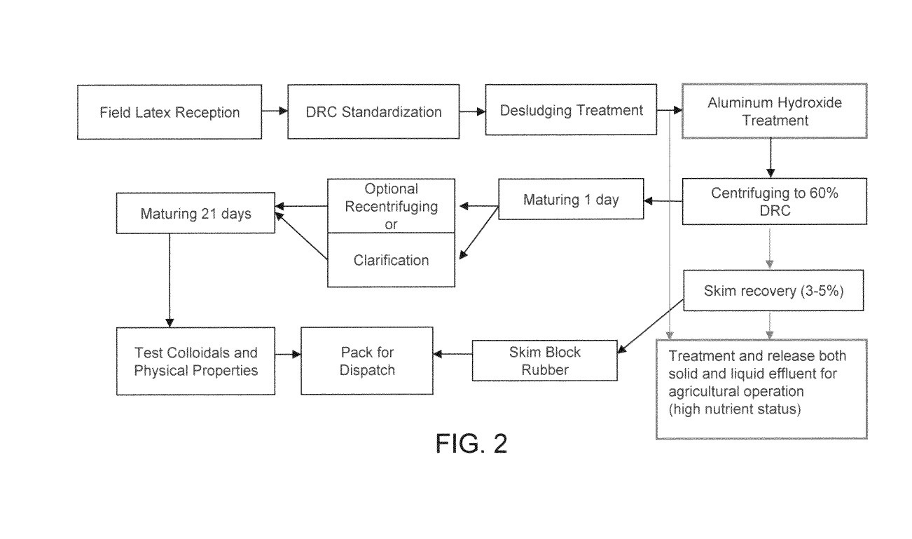

FIG. 2 shows an embodiment of the method steps for the manufacture of aluminum hydroxide-modified NRL of the present disclosure. The complete cycle of production and potential waste recovery and re-use highlights the ecologically friendly nature of the whole production process. The production process does not require additional capital equipment expenditures and can be a “closed loop” process meaning no waste. Results from a glove manufacturer's incoming quality control evaluation reveals that the extractable protein levels are significantly less with the aluminum hydroxide treatment (see Table 1a and Table 1b). The results of Table 1a and Table 1b illustrate that with an aluminum hydroxide-modified NRL of the present disclosure, there is a significant reduction in protein levels in both liquid and cast films compared to unmodified NRL.

TABLE 1a
Modified Lowry Total Protein Results of the Aluminum
hydroxide-modified NRL (incoming control evaluation)

| | Control NRL | |
|---|---|---|
| Aluminum hydroxide-modified NRL Protein | Protein | |
| “Liquid” (μg/g) | “Liquid” (μg/g) | % Change |
| 44.81 | 441.65 | 91 |
| | Control NRL | |
| Aluminum hydroxide-modified NRL Protein | Protein | |
| “Film” (μg/g) | “Film” (μg/g) | % Change |
| 47.97 | 436.58 | 89 |

TABLE 1b
Modified Lowry Total Protein Results of the Aluminum hydroxide-
modified NRL (incoming control evaluation)

| Aluminum hydroxide-modified | Control NRL | |
|---|---|---|
| NRL Protein | Protein | |
| “Liquid” (μg/g) | “Liquid” (μg/g) | % Reduction |
| <50 | 2,160 | >98 |
| Aluminum hydroxide-modified | Control NRL | |
| NRL Protein | Protein | |
| “Film” (μg/g) | “Film” (μg/g) | % Reduction |
| <50 | 439 | >89 |

As briefly described above, treated NRL materials produced from the various methods of the present disclosure can be useful in a variety of applications, including, but not limited to, medical, health care and personal care products, for example, examination and surgical gloves, condoms, breather bags, latex tubing, probe covers, and catheters, along with other applications such as threads, foams, cold seal and pressure sensitive adhesives, and balloons.

Foamed latex articles of the present disclosure (made from Aluminum Hydroxide-modified NRL of the present disclosure) are capable of withstanding mechanical shear as the aluminum hydroxide-modified NRL is more stable than the standard NRL, as illustrated in Tables 2a-c and 3 which show the colloidal properties of various embodiments of aluminum hydroxide-modified NRL of the present disclosure Tables 2a, 2b and 2c show the results of various embodiments of aluminum hydroxide-modified NRL of the present disclosure—high and low ammonia using a double centrifugation process. Table 3 shows the results of an embodiment of an aluminum hydroxide-modified NRL of the present disclosure using a single centrifugation process. An aluminum hydroxide-modified NRL of the present disclosure has a reduced amount of non-rubber impurities, as compared to untreated NRL. The reduction in non-rubber impurities is due to the aluminum hydroxide mixture/protein removal process. The amount (%) of non-rubber impurities remaining in an aluminum hydroxide-modified NRL of the present disclosure can be determined by subtracting the dry rubber content (%) from the total solid content (%). As detailed in Table 2b, in an embodiment, an aluminum hydroxide-modified NRL of the present disclosure comprises about 0.48% non-rubber impurities (60.57% -60.09%=0.48%). As detailed in Table 2c, in an embodiment, an aluminum hydroxide-modified NRL of the present disclosure comprises about 0.42% non-rubber impurities (61.61% -61.19% =0.42%). As detailed in Table 3, in an embodiment, an aluminum hydroxide-modified NRL of the present disclosure comprises about 1.05% non-rubber impurities (61.08% -60.03% =1.05%). In an embodiment, the low levels of non-rubber impurities of a aluminum hydroxide-modified NRL of the present disclosure has a direct impact on the opacity. In an embodiment, the low levels of non-rubber impurities of a aluminum hydroxide-modified NRL of the present disclosure has a direct impact on both the shelf life of the latex and the process stability of the latex. In an embodiment, the low levels of non-rubber impurities of a aluminum hydroxide-modified NRL of the present disclosure has a direct impact on the permeability to inflation gases, such as helium and air, when the aluminum hydroxide-modified NRL of the present disclosure is manufactured as a balloon envelope. In an embodiment, the low levels of non-rubber impurities of a aluminum hydroxide-modified NRL of the present disclosure has a direct impact on the inflation time permeability to inflation gases, such as helium and air, when the aluminum hydroxide-modified NRL of the present disclosure is manufactured as a balloon envelope. In an embodiment, the low levels of non-rubber impurities of a aluminum hydroxide-modified NRL of the present disclosure has a direct impact on the initial tensile modulus when the aluminum hydroxide-modified NRL of the present disclosure is manufactured as an extruded thread. In an embodiment, the low levels of non-rubber impurities of a aluminum hydroxide-modified NRL of the present disclosure has a direct impact on the stretch before breaking when the aluminum hydroxide-modified NRL of the present disclosure is manufactured as an extruded thread.

There are over 40,000 types of products made from natural rubber latex; the most prominent are dipped goods encompassing nearly 50% of latex production (gloves, condoms, balloons, breather bags, tubing). Other products made from latex include foam products (mattresses, pillows, and cushions), adhesives (pressure sensitive applications, footwear, and carpet backing), and elastic thread. The reduction in certain non-rubber constituents in the source material lends to the characteristic of being more stable and therefore having a longer shelf life compared to the standard natural rubber latex.

TABLE 2a
Colloidal Properties of an Embodiment of an aluminum hydroxide-modified
NRL of the Present Disclosure- High and Low Ammonia Fabricated Using a
Double Centrifugation process

| | | Typical | | Typical | |
|---|---|---|---|---|---|
| | | Aluminum | | Aluminum | |
| | | hydroxide- | | hydroxide- | ISO |
| | Specifications | modified NRL | Specifications | modified NRL | Standard |
| Property | (HA) | (HA) | (LA) | (LA) | No. |
| Viscosity cps | 20-100 | 81 | 20-100 | 92 | 1652 |
| (sp 2/60) | | | | | |
| Total solid | 60.0-61.5 | 60.88 | 60.0-61.5 | 60.34 | 124 |
| content, % | | | | | |
| Alkalinity (%) | 0.65-0.8 | 0.71 | 0.20-0.29 | 0.24 | 125 |
| VFA no. | 0.7 maximum | 0.018 | 0.07 | 0.019 | 506 |
| | | | maximum | | |
| Mechanical | 650 seconds | 1860 | 650 seconds | 1870 | 35 |
| Stability | minimum | | minimum | | |
| Coagulum | 100 maximum | 23 | 100 maximum | 19 | 706 |
| (mesh# 80) ppm | | | | | |
| pH | 10.5-11.5 | 10.87 | 9.5-10.5 | 9.89 | 976 |
| Antigenic Protein | <10 | 2.7 | <10 | 2.7 | ASTM |
| (ELISA) μg/dm² | | | | | 6499-07 |
| Total Extractable | <200 | <50 | <200 | <50 | ASTM |
| Protein (Modified | | | | | 5712-05 |
| Lowry) μg/dm² | | | | | |

TABLE 2b
Colloidal Properties of an Embodiment of an aluminum hydroxide-modified
NRL of the Present Disclosure- High and Low Ammonia

| Properties Tested | Specification (LA) | | Test Result | Specification (HA) | | Test Result |
|---|---|---|---|---|---|---|
| Dry rubber content, % | 60.00 | minimum | 61.28 | 60.00 | minimum | 60.09 |
| Total solid content, % | | | 61.77 | | | 60.57 |
| Non-rubber impurities, % | | | 0.49 | | | 0.48 |
| Alkalinity as NH₃, % | 0.29 | maximum | 0.29 | 0.60 | minimum | 0.84 |
| Volatile fatty acid | 0.2 | maximum | 0.015 | 0.2 | maximum | 0.011 |
| number (VFA No.) | | | | | | |
| KOH No: | 1.0 | maximum | 0.32 | 1.0 | maximum | 0.28 |
| Mechanical Stability | 650 | minimum | 1140 | 650 | minimum | 1500 |
| (MST), seconds | | | | | | |
| pH | | | 10.03 | | | 10.55 |
| Coagulum Content, % | 0.05 | maximum | 0.005 | 0.05 | maximum | 0.004 |
| Micro coagulum | 0.01 | maximum | 0.006 | 0.01 | maximum | 0.005 |
| Content, % | | | | | | |
| Brookfield Viscosity | 120 | maximum | 98 | 120 | maximum | 75 |
| 60 tsc, (sp2/60) 23° C. | | | | | | |
| ZOV₅ % | 30 | maximum | −5.61 | 30 | maximum | 2.00 |
| ZOV₆₀ % | 30 | maximum | −2.55 | 30 | maximum | 6.67 |
| ZST, seconds | 100 | minimum | 210 | 100 | minimum | 120 |
| ZHST, seconds | 300 | minimum | 1230 | 300 | minimum | 720 |

TABLE 2c
Colloidal Properties of an Embodiment of an aluminum
hydroxide-modified NRL of the Present Disclosure

| Properties Tested | Specification (LA) | | Test Result |
|---|---|---|---|
| Dry rubber content, % | 60.00 | minimum | 61.19 |
| Total solid content, % | | | 61.61 |
| Non-rubber impurities, % | | | 0.42 |
| Alkalinity as NH₃, % | 0.29 | maximum | 0.29 |
| Volatile fatty acid number (VFA No.) | 0.2 | maximum | 0.009 |
| KOH No: | 1.0 | maximum | 0.28 |
| Mechanical Stability (MST), seconds | 650 | minimum | 910 |
| pH | | | 10.02 |
| Micro coagulum Content, % | 0.01 | maximum | 0.005 |
| Coagulum Content, % | 0.05 | maximum | 0.004 |
| Brookfield Viscosity | 120 | maximum | 97.5 |
| 60 tsc, (sp2/60) 23° C. | | | |
| ZOV₅, % | 30 | maximum | −5.64 |
| ZOV₆₀, % | 30 | maximum | 1.03 |
| ZST, seconds | 100 | minimum | 195 |
| ZHST, seconds | 300 | minimum | 1370 |

TABLE 3
Colloidal Properties of an Embodiment of an aluminum
hydroxide-modified NRL of the Present Disclosure
Fabricated Using a Single Centrifugation process

| Properties Tested | Specification | | Test Result |
|---|---|---|---|
| Dry rubber content, % | 60.00 | min | 60.03 |
| Total solid content, % | 62.00 | max | 61.08 |
| Alkalinity as NH₃, % | 0.60 to 0.75 | | 0.60 |
| Volatile fatty acid number | 0.50 | max | 0.03 |
| (VFA No.) | | | |
| KOH No: | 0.60 | max | 0.43 |
| Mechanical Stability (MST), | 475 | min | 490 |
| seconds | | | |
| pH | 10.50 | min | 10.90 |
| Coagulum Content, % | 0.01 | max | 0.002 |
| Brookfield Viscosity | 120 | max | 55 |
| 60 tsc, (sp2/60) 23° C. | | | |
| ZOV₅, % | 30 | max | 13.64 |
| ZOV₆₀, % | 30 | max | 15.45 |
| ZST, seconds | 75 | min | 81 |
| ZHST, seconds | 300 | min | 322 |
| Mg ppm | 30 | max | 24 |

Zinc oxide is a very common ingredient in natural rubber latex compounding. Zinc oxide is a cure activator for NR latex. Zinc oxide enables efficient curing of natural rubber latex products. Latex that is sensitive to zinc oxide can go through dramatic increases in viscosity up to 10 times the original viscosity. This can make it difficult to produce any product with NR latex. The inclusion of ZnO has a tendency to destroy or destabilize latex. ZST (zinc oxide stability time) is a measure of the mechanical stability of the latex after the addition of a specified amount of zinc oxide. ZOV (zinc oxide viscosity) is a measure of the viscosity of a latex after the addition of a specified amount of zinc oxide.

Apart from removing proteins, the naturally developing stabilizers like the higher fatty acids are also being extracted in a process of the present disclosure. The complete removal of proteins results in lowering the natural antioxidant capability of the latex, and like synthetic rubbers, supplementary antioxidants may need to be added. Removal of the rubber bound proteins (about 25% of the proteins present initially) inside the latex particles can be accomplished using a single or double centrifugation process of the present disclosure. The retention in a double centrifuged aluminum hydroxide-modified NRL of the present disclosure is being seen when extractable protein (EP) values or powdered sheet values are examined which show migration of the rubber bound protein to the powder. By modifying the dispersion of aluminum hydroxide, the process of fabrication (for example, the centrifugation setting), the time of application, and the retention times, these issues can be addressed. A single centrifuged aluminum hydroxide-modified NRL of the present disclosure may require added stabilizer and NS Antioxidant for improved processibility. However the non-rubber debris retained is predominantly the non proteinous materials and there is a small percent of the extractable protein. In an embodiment, a single centrifuged aluminum hydroxide-modified NRL of the present disclosure is recommended for products where there is leaching post manufacturing.

Natural rubber latex foam is gaining increasing re-acceptance by consumers and retailers as a premium bedding component as well as recognition as a green recyclable material from a sustainable renewable natural resource. NRL use is predicted to increase substantially due to the green nature as a natural product and a growing global movement. Latex foam is conventionally manufactured using one of two manufacturing processes—Dunlop process and Talalay process. Dunlop process is the traditional manufacturing process where the latex is poured into a mold typically on a continuous conveyor system, covered and baked. After the process, the molded foam material is introduced into a water bath for a quick rinse, followed by drying. The Talalay process involves vacuuming the latex while it is being frothed, then freezing it to stabilize the material. The key ingredient to both the Dunlop and Talalay process is having a stable material. Previously a mixture of natural rubber latex and a synthetic material such as styrene butadiene rubber (SBR) has been used for latex foam product. The SBR is used because SBR is a lower cost material and also SBR helps stabilize the mixture.

Due to the emphasis on the soundness of sleep and the increased education of consumers, one-sided, no-flip mattresses are becoming the industry standard. Latex's luxurious feel and controlled resilience separate it from synthetic foam source materials. However, being a natural product, there can be some variability with NRL properties and hence many manufacturers often do blend styrene butadiene rubber latex (SBR) and NRL for greater process uniformity. With consideration of product impact on the environment, there is an ongoing global effort to increase the blend to a higher percentage of NRL vs. SBR and meet the requirements of the EU-Eco-label. Manufacturers need to consider the product life cycle and use sustainable materials, as well as limit the use of eco-toxic compounds and residues, while promoting a more durable product. An aluminum hydroxide-modified NRL of the present disclosure, being a stable sustainable raw material, meets environmental initiatives and other regulatory requirements.

Manufacturers have been switching to natural rubber latex to produce foam and the aluminum hydroxide-modified NRL of the present disclosure is a good alternative material to switch to due to its stable nature, with the added cost benefit of reducing the amount of compounding additives, such as whitening agents and fragrances. In an embodiment, an aluminum hydroxide-modified NRL of the present disclosure is used in a Dunlop process to fabricate a foam product having improved physical and mechanical properties compared to a foam product fabricated from un-modified NRL. In an embodiment, an aluminum hydroxide-modified NRL of the present disclosure is used in a Talalay process to fabricate a foam product having improved physical and mechanical properties compared to a foam product fabricated from un-modified NRL. The aluminum hydroxide-modified NRL of the present disclosure is more stable than un-modified NRL, and can allow manufacturers the opportunity to increase their blend ratio to a more natural mixture, which is a major priority in today's “green” society.

Foam articles manufactured from unmodified NRL can have one significant downside: they can emit an odor for days or even weeks. A foam article manufactured from an aluminum hydroxide-modified NRL of the present disclosure, having a reduced concentration of proteins, and a reduced concentration of non-rubber impurities, exhibit less odor as compared to foam articles manufactured from unmodified NRL. In an embodiment, an aluminum hydroxide-modified NRL of the present disclosure can be formed into a foamed latex article, such as, for example, bedding components and/or pillows. In an embodiment, a foamed latex article of the present disclosure can exhibit less odor and higher opacity (“whiter”) than comparable latex foams. In an embodiment, a foamed latex article of the present disclosure can comprise a blend of treated NRL and other components, such as, for example, styrene butadiene rubber, and optionally other components, such as stabilizers, fillers, and foaming agents. Conventional foam manufacturing processes require a latex solution (compounded latex) to undergo beating and whisking to generate foam with uniform air cell sizes. Thus, stability to withstand shear is desirable in latex compositions that are to be foamed. The increased stability of an aluminum hydroxide-modified NRL of the present disclosure allows foam manufacturers the ability to increase their blend of a natural product, addressing a growing global initiative. The finished product has a cleaner appearance with a significant reduction of odor when compared to foam made from standard NRL. Treatment of field latex with Al(OH)₃ traps and removes proteins and other non-rubber impurities, reducing odor contributing bacteria and the subsequent need of fragrance.

Table 4 depicts the key performance characteristics for foam products; density, compressive strength and indentation force deflection. The results illustrated are reported by a leading bedding manufacturer and derived from a sample of 100% natural rubber latex foam made with an aluminum hydroxide-modified NRL of the present disclosure. Overall, foams made from an aluminum hydroxide-modified NRL of the present disclosure have better stability, a cleaner appearance and significantly reduced odor over foams made with unmodified (standard) NRL.

TABLE 4
Physical Properties of Foam Manufactured from an Aluminum
Hydroxide-Modified NRL of the Present Disclosure

| Test | Details | Results | | |
|---|---|---|---|---|
| Apparent | 20-100 | 91.1 kg/m³* | | |
| Density | | | | |
| | | Strain | Stress (psi) | Stress (kPa) |
| Compressive | 50 mm/min | 10% | 0.12 ± 0.02 | 0.8 ± 0.2 |
| Strength | 0.01N | 25% | 0.21 ± 0.04 | 1.7 ± 0.3 |
| | threshold | 50% | 0.50 ± 0.06 | 3.4 ± 0.4 |

| | | Mean Values ± Range | |
|---|---|---|---|
| | | (lb units) | |
| Indentation | Reduced Size | IFD-25% | 33 ± 2 |
| Force | Indentor | IFD-65% | 99 ± 4 |
| Deflection | (50.8 mm | Support Factor | 3.0 |
| | diameter) | | |

Apparent Density: a measure of the “fluffiness” of a material in its supplied form and the type of usage the foam will receive. The higher the density, the higher the durability and quality of the foam. It is the measurement of pricing as well. The higher the density, the longer the product will last. Apparent density is calculated as the mass of material divided by its volume (including voids inherent in the material as tested) using calipers and balance.
The Compressive Strength: measures the maximum compressive load (sustained by a specimen) divided by the original cross-sectional area. It is the ability of a material to resist a uniaxial compressive load.
Indentation Force Deflection (IFD): measurement of foam firmness and the surface feel of the foam. Firmness is independent of foam density, although it is often thought that higher density foams are firmer. It is possible to have high density foams that are soft - or low density foams that are firm, depending on the IFD specification. IFD specification relates to comfort. The IFD is measured by indenting (compressing) a foam sample 25 percent of its original height. The amount of force (in pounds) required to indent the foam is its 25 percent IFD measurement. The more force required, the firmer the foam. Flexible foam IFD measurements range from 10 pounds (super soft) to about 80 pounds (very firm).
The Support Factor: the foam's ability to “push back” against weight and prevent the foam from “bottoming out”. Support Factor is a ratio of 65% IFD: 25% IFD. The higher the support factor, the better quality of the foam. The foam will support weight better with a higher support factor. Foams with support factors of 2.0 or above are better suited for load bearing applications like seat cushions.

NRL was the first polymer to be used to produce pressure sensitive adhesives (PSA). Interestingly, NRL is the only material that sticks to itself, making it ideal for cold seal adhesives. NRL has several key physical properties that are advantageous when used in pressure sensitive and contact adhesive formulations, including, but not limited to, a low glass transition temperature (Tg), about −70° C. (vs. polychloroprene at about −40° C.) and low surface energy, which enable NRL to effectively flow over surfaces. NRL can lose its tack and adhesion properties over time due to oxidative degradation and embrittlement that can be overcome with the use of antioxidants. Additionally, the proteins in NRL have the ability to cause an allergic reaction manifested as sensitized skin. Sensitization can be resolved with the use of aluminum hydroxide-modified NRL of the present disclosure with no detectable carryover of proteins into the end product. The aluminum hydroxide-modified NRL compositions of the present disclosure can also be useful in adhesive applications. The use of aluminum hydroxide-modified NRL compositions in adhesive applications, including, but not limited to, medical dressings and bandage applications, cold seal, shoe, contact and foam fabricating adhesives, can reduce and/or eliminate such allergic reactions.

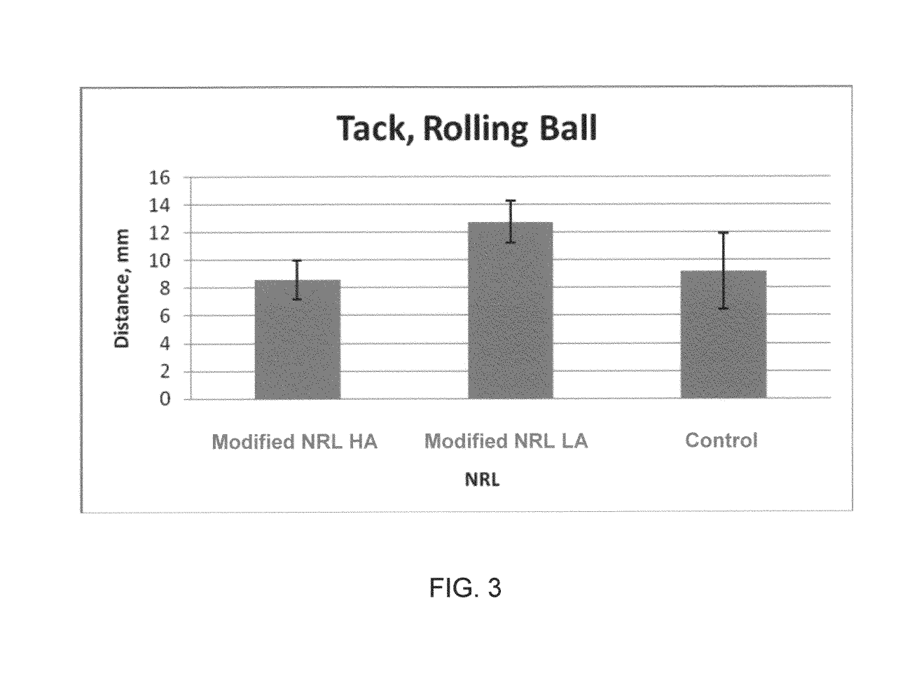

In an embodiment, an aluminum hydroxide-modified NRL of the present disclosure is used to fabricate an adhesive material having improved physical and mechanical properties compared to an adhesive material fabricated from un-aluminum hydroxide-modified NRL. In an embodiment, an adhesive material made with latex can be sprayed, applied to a cloth or applied directly to the desired object. The key physical performance attributes when selecting an adhesive material is coating, spraying and stability of the latex material. Aluminum hydroxide-modified NRL of the present disclosure, due to the removal of non-rubber impurities in latex, has been found to have exceptional high shear stability compared to standard un-modified natural rubber latex. The processing characteristics of aluminum hydroxide-modified NRL of the present disclosure in both spray and coating applications have demonstrated that aluminum hydroxide-modified NRL performs better than standard natural rubber latex, as detailed in the Tables below. The use of aluminum hydroxide-modified NRL of the present disclosure in latex adhesive markets is of particular importance since there are no post leaching processes used to reduce latex protein values. In an embodiment, aluminum hydroxide-modified NRL of the present disclosure has approximately 90% fewer proteins than standard latex thus adhesive products made with this material are much safer for end users. Using an industry-standard, air-assisted spray gun (Graco) with an air inlet pressure of 40 psi and spray orifice of 0.07-0.086, a comparison study between low ammonia (LA) and high ammonia (HA) adhesives made from aluminum hydroxide-modified NRL of the present disclosure and a control was performed to assess the overall spray ability. The latex spraying process gave no clogging of the spray head and the viscosity and stability were found to be acceptable. The tack of the latex adhesive samples was examined, using the rolling ball method and were found to be comparable (FIG. 3). Notably, the aluminum hydroxide-modified NRL of the present disclosure has greater reproducibility, error bars, than the control as the aluminum hydroxide-modified NRL is a standardized source material, demonstrating a more consistent product compared to regular latex. Results indicate that stable, aluminum hydroxide-modified NRL performs well in spraying applications for adhesives without compromising tack properties. All films dried clear without any observable inclusions or irregularities. Table 5 illustrates that the removal of the non-rubber impurities does not affect the physical properties. The aluminum hydroxide-modified NRL and standard natural rubber latex were subjected to high shear stress. Specifically, the individual latices were placed in a high speed blender and evaluated for stability properties before and after spraying. The aluminum hydroxide-modified NRL having ultra low protein content has exceptional high sheer stability compared to standard NRL, see Table 6. This stable nature of the modified latex is due to the removal of non-rubbers in the liquid latex. Proteins, if left in latex will breakdown over time and lead to stability issues as seen in the control sample.

TABLE 5
Waring Blender Stability Test

Waring Blender Stability
Test (min)

| NRL | Before spray | After spray |
|---|---|---|
| Control/LA | 5:49 gel | 4:44 gel |
| Modified/LA | 10:00 stable | 10:00 stable |
| Modified/HA | 10:00 stable | 10:00 stable |

TABLE 6
Antigenic Protein Results in Adhesives

ELISA D6499-07 (μg/g)

| Source | Sample 1 | Sample 2 |
|---|---|---|
| Aluminum | 1.6 | 2.4 |
| hydroxide- | | |
| modified NRL | | |
| Control A | 624.5 | 76.3 |

Many cohesive medical bandages use natural rubber latex as an adhesive, however if the standard latex is not modified, it can pose a potential risk of provoking a sensitive skin reaction. Non-dipped good applications, such as cohesive bandages, should use low protein latex—as post leaching practices are not available for this type of product. A combination of low protein, greater stability, improved processing makes the aluminum hydroxide-modified NRL of the present disclosure the next generation of NRL for adhesive applications.

Table 7 demonstrates that bandages produced with an aluminum hydroxide-modified NRL adhesive of the present disclosure have a 20-fold lower protein content than bandages made with adhesive comprising standard NRL.

TABLE 7
Modified Lowry Protein Result μg/g

| Aluminum hydroxide- | | |
|---|---|---|
| modified NRL | NRL | % Reduction |
| 50 μg/g | 1000 μg/g | 95 |

Thus, adhesives made from treated NRL of the present disclosure can exhibit a 5 fold, 10 fold, 20 fold or more reduction in antigenic protein content. In an embodiment, the use of treated NRL for adhesives can result in a reduction of at least about 85%, 90%, 91%, 92%, 93%, 94%, 95%, 96%, 97%, 98%, 99% or more in antigenic protein concentration in the adhesive and/or elastomeric portion thereof over conventional NRL adhesives. In an embodiment, an adhesive made from a treated NRL can comprise less than about 100 μg/g, 75 μg/g, 50 μg/g, 40 μμ/g, 25 μg/g, 10 μg/g, 5 μg/g, 2 μg/g, or 1 μg/g of antigenic protein.

Significantly the aluminum hydroxide-modified NRL of the present disclosure having ultra low protein content has exceptional high shear stability compared to standard natural rubber latex. Furthermore, gel times can be customized (through additives) to suit the particular application needs. The aluminum hydroxide-modified NRL adhesive of the present disclosure stands above the standard NRL demonstrating greater stability, while maintaining all the positive performance characteristics. A combination of greatly reduced protein, improved processing, and effective adhesion makes the aluminum hydroxide-modified NRL adhesive of the present disclosure the next generation natural rubber latex adhesive.

Water is not only important to human survival but also important to many sectors of the economy. The future of any society, people and business, depends on the preservation of water resources as part of the sustainable development process. Companies need to think about how much water they are using and consuming in their processes. The true cost of manufacturing is measured as the sum of the total costs throughout the production cycle. Sometimes more can be less. Water and energy stress caused by the growing global population is expected to reach historic proportions, driving supply down and costs up, and directly affecting business operations according to a recent United Nations report. Within the dipped goods industry increased efficiency has been demonstrated by reducing processes, such as excessive washing and leaching. This can significantly reduce the manufacturers' water and energy consumption, and by simultaneously reducing harmful leachates (e.g., zinc).

Dipped products consume the majority of latex during processing. End product applications made from a latex dipping process includes, but are not limited to, balloons, exam and surgical gloves, condoms, breather bags and tubing. A dipped goods manufacturing process is very energy intense consuming large quantities electricity and water. The production involves dipping a former into latex to achieve a desired thickness, followed by drying then leaching in hot water, then drying. The post leaching steps are done to eliminate residual chemicals used during the latex compounding and also to reduce the protein levels in finished articles. Aluminum hydroxide-modified NRL of the present disclosure allows manufacturers to reduce some of these post leaching processes since aluminum hydroxide-modified NRL comprises significantly fewer proteins in the starting latex material. This benefit allows manufacturers to reduce their environmental impact and also production cost.

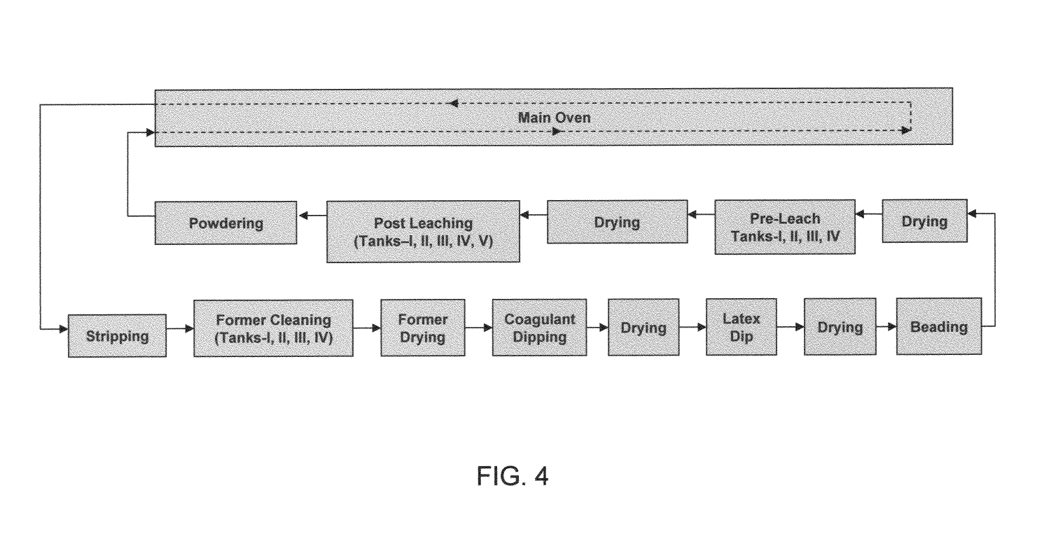

FIG. 4 is a flow chart showing the production steps for a typical modern glove line with the following parameters:
Latex TSC. Range˜32%
Coagulant=>CaCl₂+Ca(NO₃)₂[˜20%]
Total No. Of Pre-Leach—4; [Pre leach ranges 55-60° C. cooling down to 40-40° C.]
Total No. Of Post Leach—5 [Post Leach (I) ranges 55-60° C. and rising to 70-75° C.]

In an embodiment, using an aluminum hydroxide-modified NRL of the present disclosure can reduce the number of processing steps in a glove production process. In an embodiment, the methods described herein can, in various aspects, reduce the amount of washing and/or leaching necessary to provide a finished glove having desirable properties, potentially resulting in substantial reductions in both energy and water consumption and a reduction in the discharge of potentially harmful leachates into the environment.

Table 8 describes the savings that can be achieved by implementing the methods of the present disclosure in a conventional glove manufacturing line. At a production rate of 110,000 pairs per day, implementation of the inventive methods can result in a savings of about $472,500 per year. The overall environmental impact is minimized resulting in an increase of production cost savings.

TABLE 8
Water and Energy Reduction

| | | Standard | Modified | | Cost | TOTAL COST | |
|---|---|---|---|---|---|---|---|
| SL | | NRL | NRL | Difference | Per Unit | Per Day | Per Year |
| # | Particulars | Per Day | Per Day | Per Day | $ | $ | $ |
| 1 | Water | 36 KL | 14.4 KL | 21.6 KL/DAY | 16.7/KL | $360 | $108,000 |
| | Consumption | | | | | | |
| | (Kilolitres) | | | | | | |
| 2 | Energy | 684,000 | 288,000 | 396,000 KCAL | 0.12/KWHR | $1,215 | $364,500 |
| | Consumption | KCAL | KCAL | | | | |
| | (Kcals/Kwh) | | | | | | |
| | | | | | TOTAL SAVINGS | $1,575 | $472,500 |

1 KW = 861 KCAL/HOUR THEREFORE 396,000 KCALS/HR/861 = 459.9 KWH = ~460 KWH
460 × 24 HRS × $0.11 = 1214.4 = ~1215/DAY
1215/DAY × 300 = 364,500

Therefore at a production rate of 110,000 pairs per day and using the data in Table 8, the cost saving per pair is $0.0143 with the benefits accruing:
(1) a significant reduction in the utilization of water;
(2) a significant reduction in energy cost;
(3) the Zn levels in the total discharges are reduced.

However, depending upon the particular plant line configurations, processing methodologies and the local costs of water and energy, the cost savings will differ accordingly.

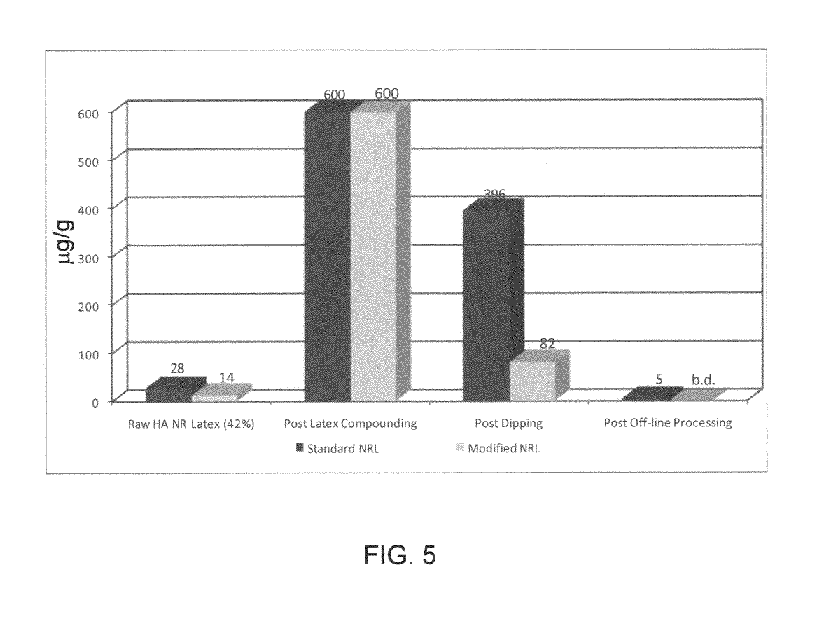

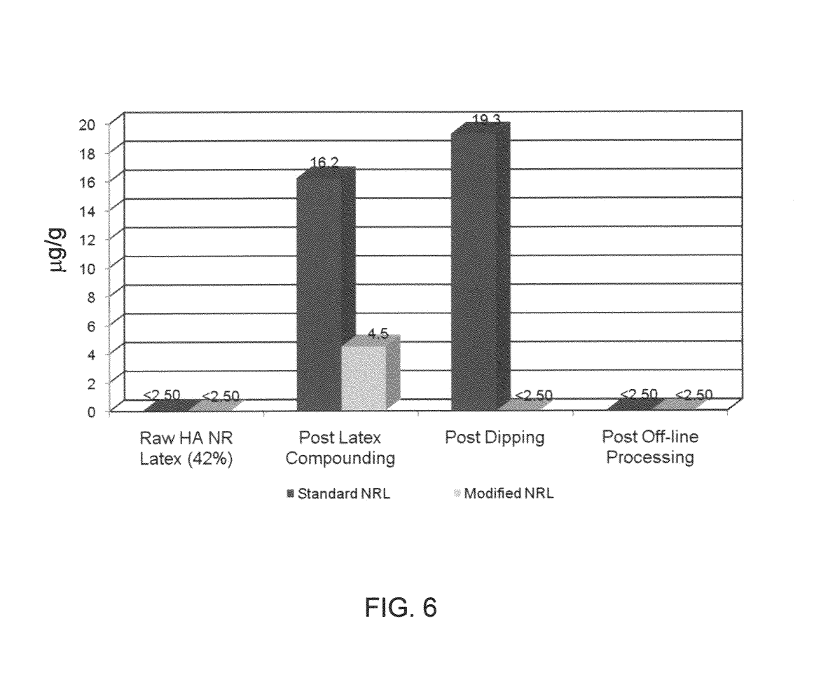

The aluminum hydroxide-modified NRL of the present disclosure provides significant cost value when compared to other synthetic latices. As illustrated in FIG. 2 in conjunction with FIG. 5 and FIG. 6, the number of manufacturing steps required to achieve acceptable protein levels is reduced. FIG. 5 is a comparison chart of aluminum hydroxide-modified NRL of the present disclosure and standard NRL using the modified Lowry protein test method. Gloves made with aluminum hydroxide-modified NRL of the present disclosure achieve low protein levels after post dipping while standard NRL requires post off line leaching to achieve low protein levels. Gloves made with aluminum hydroxide-modified NRL achieve low protein levels after post dipping while standard NRL requires post off line leaching to achieve low protein levels. FIG. 6 is a comparison chart of aluminum hydroxide-modified NRL of the present disclosure and standard NRL using the ELISA method. Gloves made with aluminum hydroxide-modified NRL of the present disclosure maintain low protein status at all stages of production, while the standard NRL gloves required off-line post leaching to achieve low protein status. Both examination and surgical gloves made with aluminum hydroxide-modified NRL of the present disclosure comprised significantly fewer proteins than Hevea control gloves. This indicates that glove manufacturers using the aluminum hydroxide-modified NRL of the present disclosure as their raw feedstock can be within ASTM glove protein compliance with only pre-leaching. Hence, these glove manufacturers will offer gloves with acceptable protein levels and potentially reduce their production costs. Additionally, the aluminum hydroxide-modified NRL of the present disclosure can require less additives such as stabilizers and whitening agents, as described in detail below.

In an embodiment, aluminum hydroxide-modified NRL of the present disclosure will allow manufacturers to achieve the recommended protein levels set forth by ASTM and SMG (<10 antigenic proteins and <200 total water extractable proteins) after post dipping, while not requiring any additional post off-line leaching processes to achieve low protein status. The opportunity to achieve the recommended protein levels after post dipping offers manufacturers using aluminum hydroxide-modified NRL time & cost savings benefits by eliminating post off-line leaching processes.

Raw, natural latex is a liquid. When dried and cured, the film dries semi-transparent yellow and comprises a yellowish oily film on the surface. Whitening agents, such as titanium dioxide or calcium carbonate, are typically added to the latex to express whiteness in the finished product or to provide a white background for which color pigments can be used. Significantly, the use of titanium dioxide can be expensive. In an embodiment, an aluminum hydroxide-modified NRL of the present disclosure can be used in the manufacture of balloons, such as, for example, toy balloons and medical balloons. Latex balloons come in a multitude of colors. Conventional balloons are manufactured from dipped natural rubber latex and can be subject to degradation from, for example, bacteria and fungi. The latex materials used to produce conventional balloons can result in yellow colored materials having oil sheens and poor gas retention. In contrast, balloons produced from an aluminum hydroxide-modified NRL of the present disclosure can, in various aspects, exhibit whiter (less colored) materials without the oil sheen observed in conventional balloons. As a result, aluminum hydroxide-modified NRL balloons of the present disclosure can require less pigment than conventional NRL balloons. While not wishing to be bound by theory, it is also believed that the reduced protein and impurity levels in an aluminum hydroxide-modified NRL of the present disclosure can, in various aspects, result in tighter rubber particle integration and improved gas retention capabilities. Thus, in one aspect, an aluminum hydroxide-modified NRL balloon of the present disclosure can retain air and/or helium better than conventional NRL balloons.

A study was performed to compare aluminum hydroxide-modified NRL CL60 against common hevea CL60 in terms of color pigmentation on balloon compounds; to compare the balloon compounds made from aluminum hydroxide-modified NRL CL60 against hevea CL60 without any pigments; and to compare the whiteness of Aluminum hydroxide-modified NRL CL60 against common hevea CL60. Aluminum hydroxide-modified NRL CL60 of the present disclosure is naturally whiter compared to common hevea CL60 due to absence of proteins and lutoids (natural occurring non-rubbers in latex). In an embodiment, the usage of aluminum hydroxide-modified NRL CL60 for balloon compounding would benefit the following: less addition of pigments to produce the same color tone and intensity and less addition of whiting agents such as Titanium Dioxide or Calcium Carbonate to increase the opacity and white index.

Aluminum hydroxide-modified NRL and common hevea CL60 were compounded into balloon grade (Pre-vulcanized version). After maturation, they were added with 3 types of pigment namely blue, red and yellow and mixed homogenously. After homogenized mixing, the color compounds were used to make thick sheets of films (˜2 mm) on a black background for comparison. The film sheets were dried at 50° C. for 24 hours and not leached. Also, no stripping aid was added to the film sheets. Balloons (small size) dipped from the study above were used in the study. Balloons were also dipped using the pigmented compounds as per following conditions for comparison: Coagulant strength: 16%; Compounds solid content: 55%; Leaching time and temperature: 15 minutes @ 50° C.; Drying time and temperature: 45 minutes @ 70° C.; Stripping aid: Feldspar powder.

In an embodiment, an inflatable latex balloon of the present disclosure comprises an aluminum hydroxide-modified natural rubber latex envelope. The balloon envelope refers to the balloon bag, having inner and outer surfaces. In an embodiment, the aluminum hydroxide-modified natural rubber latex envelope is substantially free of non-rubber impurities. In an embodiment, “substantially free of non-rubber impurities” refers to having less than 2.00% non-rubber impurities. In an embodiment, the aluminum hydroxide-modified natural rubber latex envelope has less than about 1.00% non-rubber impurities. In an embodiment, the aluminum hydroxide-modified natural rubber latex envelope has less than about 0.50% non-rubber impurities. In an embodiment, the aluminum hydroxide-modified natural rubber latex envelope is substantially free of non-rubber impurities selected from at least one of Frey-Wyssling particles or lutoids. In an embodiment, the aluminum hydroxide-modified natural rubber latex envelope has decreased permeability to inflation gasses such as helium and air as compared with an inflatable latex balloon comprising a natural rubber latex envelope. In an embodiment, the aluminum hydroxide-modified natural rubber latex envelope has increased inflation time to inflation gasses such as helium and air as compared with an inflatable latex balloon comprising a natural rubber latex envelope. In an embodiment, the aluminum hydroxide-modified natural rubber latex envelope has a higher opacity as compared with an inflatable latex balloon comprising a natural rubber latex envelope. In an embodiment, the aluminum hydroxide-modified natural rubber latex is pigmented with a color. In an embodiment, the inflatable latex balloon is for toy applications.

In an embodiment, an inflatable latex balloon of the present disclosure is made by the steps of: subjecting natural rubber latex, prior to its vulcanization, to an amount of aluminum hydroxide sufficient to adsorb non-rubber impurities to the aluminum hydroxide to create a suspension; centrifuging the suspension to separate the suspension, wherein a skim layer comprising the adsorbed non-rubber impurities is separated from an aluminum hydroxide-modified natural rubber latex liquid; removing the aluminum hydroxide-modified natural rubber latex liquid; and dipping a mold shaped like a deflated balloon into the aluminum hydroxide-modified natural rubber latex liquid to form the inflatable latex balloon. In an embodiment, an inflatable latex balloon of the present disclosure is made by the additional step of, prior to the dipping step, adding a pigment into the aluminum hydroxide-modified natural rubber latex liquid. In an embodiment, an inflatable latex balloon of the present disclosure is made by the additional step of, after the dipping step, forming a lip on a neck of the balloon; and drying the aluminum hydroxide-modified natural rubber latex liquid on the mold. In an embodiment, the amount of aluminum hydroxide sufficient to adsorb non-rubber impurities to the aluminum hydroxide is from about 0.01 pounds per hundred pounds of rubber to about 5 pounds per hundred pounds of rubber. In an embodiment, the centrifuging and removing steps are performed more than once. In an embodiment, the time to dry the aluminum hydroxide-modified natural rubber latex liquid on the mold is reduced as compared with an inflatable latex balloon that is made by dipping a mold shaped like a deflated balloon into natural rubber latex.

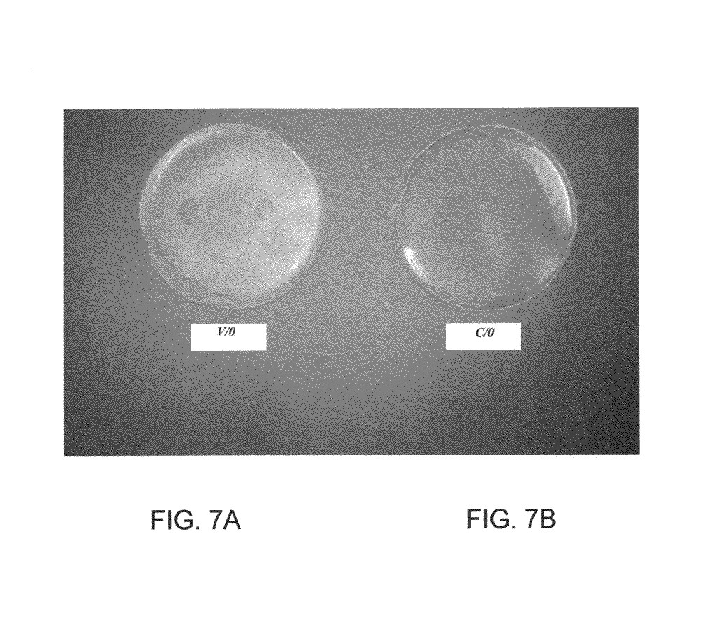

Photographs of the thick film sheets (˜2 mm) and the balloons were taken and attached for visual comparison (see FIGS. 7A, 7B, 8A, 8B, 9A, 9B, 10A, 10B, 11A and 11B). Following in Table 9 are the variants for the study.

TABLE 9
Variants for Balloon Study

| | | Balloon Compound | | | | |
|---|---|---|---|---|---|---|
| | | (vulcanized version) | | | | |
| | | | Blue | Red | Yellow | Black |
| Latex | | | Pig- | Pig- | Pig- | Pig- |
| used | | | ment | ment | ment | ment |
| for | Control | Without | (0.1% | (0.1% | (0.1% | (0.2% |
| compounding | (unvulcanized) | pigment | w/w) | w/w) | w/w) | w/w) |
| Aluminum | V/0 | V/BC/0 | V/blue | V/red | V/ | V/ |
| hydroxide- | | | | | yellow | black |
| modified | | | | | | |
| NRL | | | | | | |
| Common | C/0 | C/BC/0 | C/blue | C/red | C/ | C/ |
| Hevea | | | | | yellow | black |
| CL60 | | | | | | |

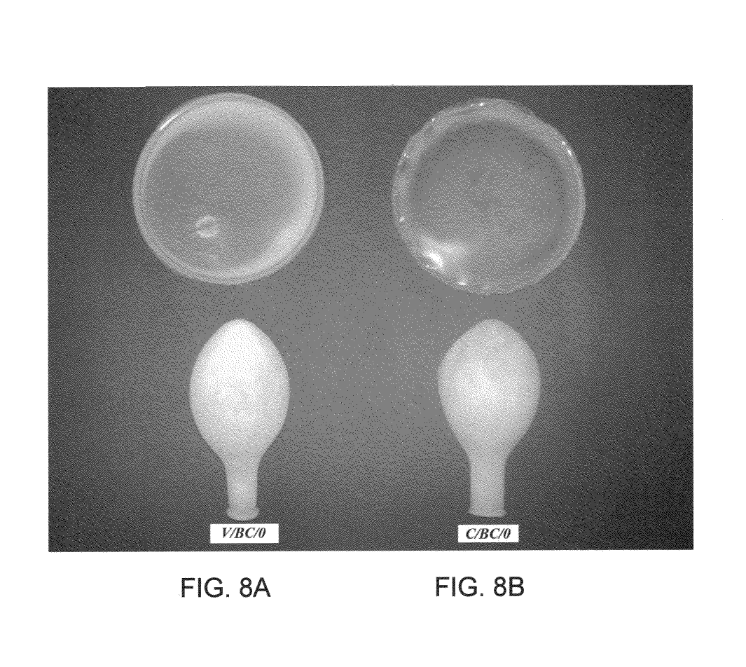

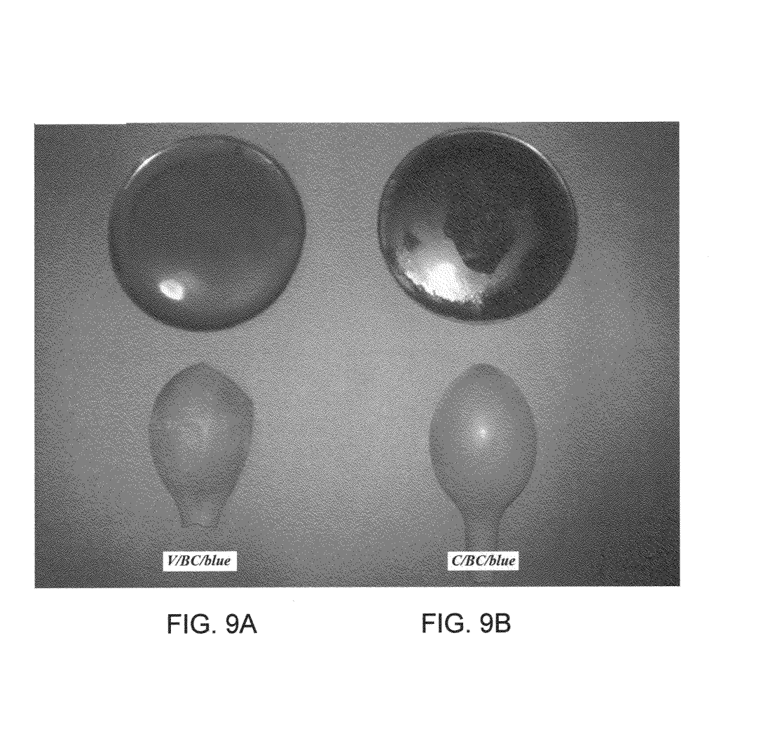

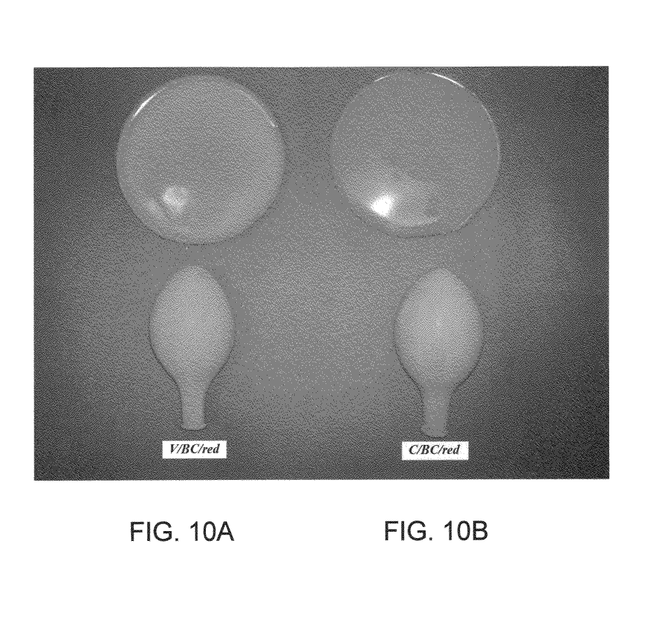

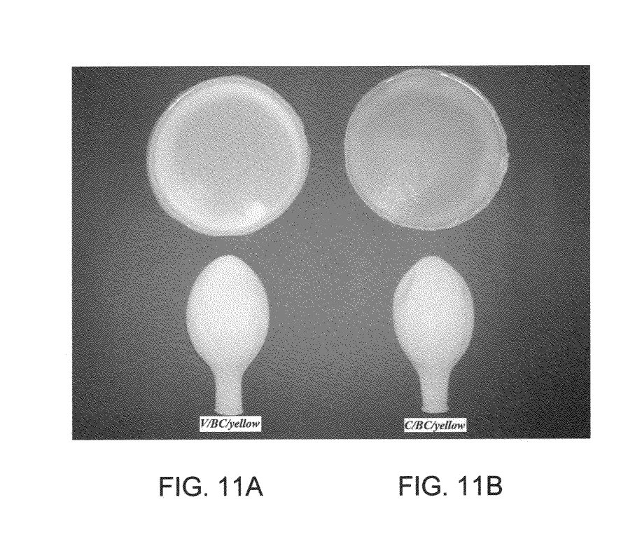

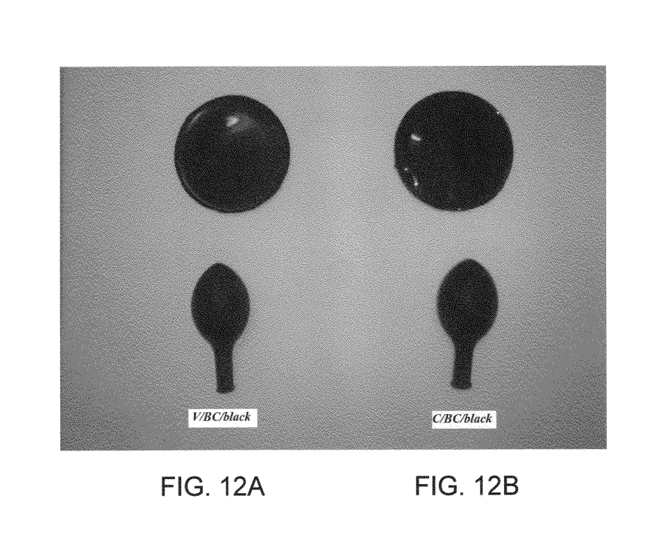

Referring to FIG. 7A and FIG. 7B, the uncompounded latex of aluminum hydroxide-modified NRL CL60 produced whiter and more transparent film sheet compared to common hevea CL60. Visually, the film sheet made from compounded aluminum hydroxide-modified NRL CL60 is more transparent and less yellowish. Also, the balloon is whiter compared to common hevea CL60 (see FIG. 8A and FIG. 8B). From FIG. 9A and FIG. 9B, the compounded common aluminum hydroxide-modified NRL CL60 produced some yellowish tone on the blue film sheet. The yellowish tone was not observed on balloon as it is thinner and was properly leached. The same yellowish tone on common hevea CL60 was observed on red film sheet (see FIG. 10A and FIG. 10B). In addition, for aluminum hydroxide-modified NRL CL60 the red balloon has a more red tone compared to common hevea CL60. The yellow balloon and the yellow film sheet made from aluminum hydroxide-modified NRL CL60 are more yellowish and brighter compared to common hevea CL60 (see FIG. 11A and FIG. 11B). The yellow tone on common hevea CL60 is quite dull. However, for black pigment visually there was no obvious difference between common hevea CL60 and aluminum hydroxide-modified NRL CL60 for both balloons and film sheets (see FIGS. 12A and 12B). The pigments added to common hevea CL60 found to settle/sediment faster compared to aluminum hydroxide-modified NRL. Therefore, pigmentation on balloon compound of common hevea CL60 requires frequent agitation to provide a homogenous mixture. However, for aluminum hydroxide-modified NRL the less stirring/mixing were required even during the pigments addition.

Because the aluminum hydroxide-modified NRL of the present disclosure is characteristically white in appearance and has a higher opacity than standard NRL, the amount and cost of the base whitening agents can be reduced. The yellowish oily film seen on the raw, natural latex film is absent on the aluminum hydroxide-modified NRL film of the present disclosure.

Moreover, when aluminum hydroxide-modified NRL is used to produce a balloon the balloon is whiter (transparent and less yellow) and therefore cleaner in appearance than the balloon produced from the standard NRL. Notably when pigments are introduced, an oily yellowish tone was commonly observed on the blue, red or yellow film sheets made from the standard NRL. In contrast, this oily tone was absent on the pigmented aluminum hydroxide-modified NRL film sheet

No significant differences between the aluminum hydroxide-modified NRL and standard NRL were detected of black pigmented films. Taken together, when the aluminum hydroxide-modified NRL is compared to the standard NRL, aluminum hydroxide-modified NRL is noticeably more white, suggesting that compounding aluminum hydroxide-modified NRL for applications, such as toy balloons, tubing and breather bags, has reduced requirement for whiteners, such as titanium dioxide or calcium carbonate. Additionally, the aluminum hydroxide-modified NRL most likely will require less pigment to achieve the same color tone and intensity as the standard NRL. Using typical industry practices, when the pigments are introduced, an oily yellowish tone was commonly observed with the blue and red in the regular latex. In contrast, the oily tone was absent on the pigmented balloons made with the modified latex. Balloons made with the modified latex produced much more vibrant colors. Additionally, the aluminum hydroxide-modified NRL will most likely require less pigment to achieve the same color tone and intensity as the standard NRL. The same amount of pigment was used for both the modified and control NRL.

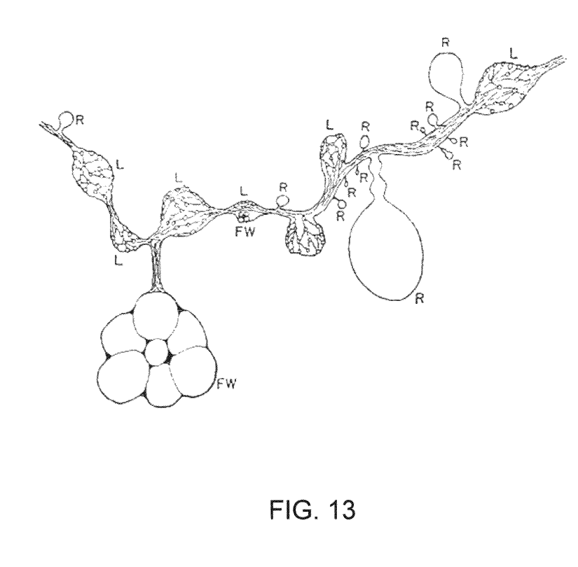

FIG. 13 shows a schematic depiction of a latex vessel—an elongated cell joined end to end with other like cells to form a type of lactiferous duct. The frequency of Frey-Wyssling particle occurrence can vary between clones. The yellow appearance of latex is due to the presence of carotenoid pigments from the Frey-Wyssling particles. In an embodiment, a method of the present disclosure uses aluminum hydroxide to modify or treat NRL which results in the removal of molecules, such as lutoid and Frey-Wyssling particles which are present in freshly tapped latex.

In an embodiment, the present disclosure relates to an inflatable latex balloon comprising an aluminum hydroxide-modified natural rubber latex envelope. In an embodiment, the aluminum hydroxide-modified natural rubber latex envelope is substantially free of non-rubber impurities. In an embodiment, the aluminum hydroxide-modified natural rubber latex envelope is substantially free of antigenic proteins. In an embodiment, the aluminum hydroxide-modified natural rubber latex envelope has inside and outside surfaces. In an embodiment, the aluminum hydroxide-modified natural rubber latex envelope has decreased permeability to inflation gasses such as helium and air. In an embodiment, the aluminum hydroxide-modified natural rubber latex envelope has increased inflation time to inflation gasses such as helium and air.

In an embodiment, the present disclosure relates to a closable, non-inflated aluminum hydroxide-modified natural rubber latex envelope having inside and outside surfaces, wherein the aluminum hydroxide-modified natural rubber envelope is inflatable with an inflation gas to expand the surfaces and provide a buoyant balloon having increased inflation time. In an embodiment, the inflated aluminum hydroxide-modified natural rubber latex envelope has an inflated diameter of from about 55 cm to about 70 cm when inflated with the inflation gas. In an embodiment, the aluminum hydroxide-modified natural rubber latex envelope has decreased permeability to inflation gasses such as helium and air. In an embodiment, the aluminum hydroxide-modified natural rubber latex envelope has increased inflation time to inflation gasses such as helium and air due to tighter rubber particle integration.

In addition to assessing the pigmentation on the aluminum hydroxide-modified NRL balloon, gas retention was also studied. A study was performed: to compare balloons made from aluminum hydroxide-modified NRL CL60 against common hevea CL60 in terms of helium and normal air retention; and to compare the balloons for weathering during conditioning under sun. Without being bound to any particular theory, it is believed that the aluminum hydroxide-modified NRL CL60 of the present disclosure, which lacks proteins and lutoids (natural occurring non-rubbers in latex), compared to common Hevea CL60 results in tighter rubber particles integration. Tighter rubber particle integration can prevent loss of gas (normal air or helium) retained in the balloons, thus leading to improved air/gas retention characteristics as compared to untreated NRL; and allow for longer inflation time, thereby enhancing and prolonging the use of the end product article balloon. Longer inflation time can be particularly beneficial for applications of balloons designed to last for more than 1 or 2 days—as indicated below by the difference in air retention from a standard NRL balloon and an aluminum-hydroxide modified NRL balloon.

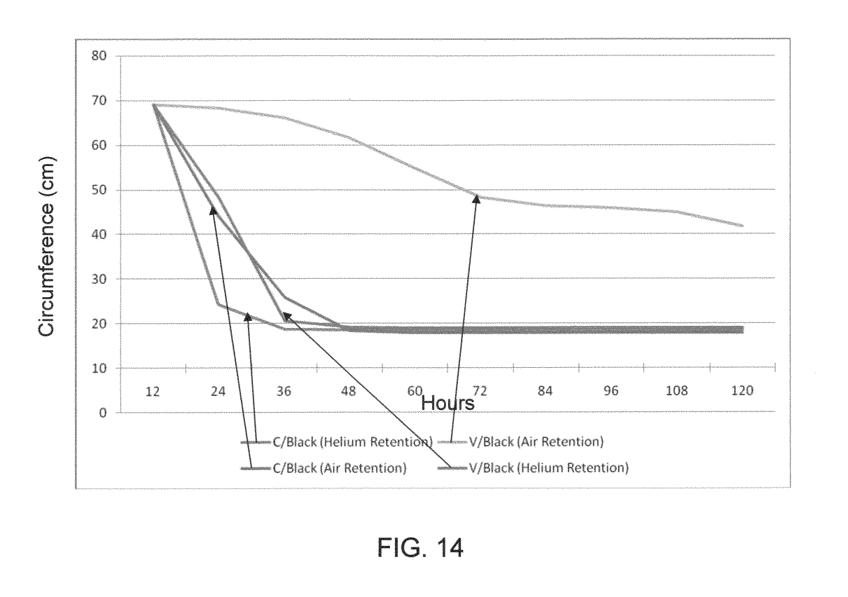

Balloons (small size) dipped from the project above were used in the study. Both the balloons made from Aluminum hydroxide-modified NRL CL60 and common Hevea CL60 were inflated to 69 cm circumference with Helium gas. Then, the balloons were hung outdoors under sun to check effect of weathering on gas retention. During weathering, all the balloons (V/Black and C/Black) turned hazy after 4 hours conditioning under the sun. The balloons' circumferences were measured at interval of 6 hours. The study was repeated with normal air. The results are tabulated in Table 10 and FIG. 14.

As illustrated in FIG. 14, the aluminum hydroxide-modified NRL demonstrated about a 50% greater retention of helium as compared to the standard NRL. The common Hevea CL60 deflated completely within 24 hours while aluminum hydroxide-modified NRL took at least 36 hours to retain the helium gas. The helium retention for aluminum hydroxide-modified NRL CL60 at 24 hours is 70.1% while for common Hevea CL60 is 34.9%. Meanwhile, for the air retention study aluminum hydroxide-modified NRL performed well by maintaining 60.6% air on the 5^{th} day compared to common Hevea CL60 deflated on the 2^{nd} day. It is believed that the removal of the non-rubber impurities using the treatment method of the present disclosure may lead to the tighter rubber particle integration, preventing the ‘wicking’ loss of gas from within the balloons.

TABLE 10
Gas Retention of Aluminum-Hydroxide Modified (“M”) NRL vs (“C”) NRL

| | | Circumference Measurement of Balloons at Intervals (cm) | | | | | | | |
|---|---|---|---|---|---|---|---|---|---|
| | | Helium Retention | | | | Normal Air Retention | | | |
| Days | Hours | M/Black | M/Black | C/Black | C/Black | M/Black | M/Black | C/Black | C/Black |
| 1 | 12 | 69.0 | 69.0 | 69.0 | 69.0 | 69.0 | 69.0 | 69.0 | 69.0 |
| | 24 | 47.8 | 48.9 | 20.8 | 27.5 | 68.0 | 68.4 | 45.5 | 42.7 |
| 2 | 36 | 21.0 | 20.2 | 18.7 | 18.5 | 66.7 | 65.3 | 28.7 | 22.9 |
| | 48 | 19.5 | 18.9 | 18.6 | 18.5 | 62.4 | 60.7 | 18.3 | 18.4 |
| 3 | 60 | 19.2 | 18.9 | 18.6 | 18.5 | 57.0 | 52.6 | 18.0 | 17.8 |
| | 72 | 19.2 | 18.9 | 18.6 | 18.5 | 48.9 | 47.6 | 18.0 | 17.8 |
| 4 | 84 | 19.2 | 18.9 | 18.6 | 18.4 | 47.1 | 45.8 | 18.0 | 17.8 |
| | 96 | 19.2 | 18.9 | 18.6 | 18.4 | 46.9 | 44.9 | 18.0 | 17.8 |
| 5 | 108 | 19.2 | 18.9 | 18.6 | 18.4 | 45.6 | 44.4 | 18.0 | 17.8 |
| | 120 | 19.2 | 18.9 | 18.6 | 18.4 | 43.8 | 39.8 | 18.0 | 17.8 |

A study was performed to compare the pick up of latex during dipping by analyzing the thickness profile and weight of balloons made from aluminum hydroxide-modified NRL CL60 against common hevea CL60. The lack of proteins and lutoids (natural occurring non-rubbers in latex) in aluminum hydroxide-modified NRL CL60 increases the latex pick up during dipping. The coagulant can pick up/coagulate more latex compound and therefore, film articles made by aluminum hydroxide-modified NRL CL60 would have more weight and thicker. Balloons (small size) dipped from the study above were used in the study. Balloons were also dipped using the pigmented compounds as per following conditions for comparison: Coagulant strength: 16%; Compounds solid content: 55%; Leaching time and temperature: 15 minutes @ 50° C.; Drying time and temperature: 45 minutes @ 70° C.; Stripping aid: Feldspar powder.

Both the balloons made from aluminum hydroxide-modified NRL CL60 and common Hevea CL60 were checked on their thickness profile using standard thickness gauge. The thickness was measured at 5 positions i.e. 1 cm, 3 cm, 5 cm, 7 cm and 9 cm from the open end (beading area) to close end. The balloons' weight were weighed using a analytical balance as well. The results are shown in Table 11.

The amount of latex picked up from the dipping process of aluminum hydroxide-modified NRL and standard NRL was assessed based on the mass of the resulting balloons made from each. Thickness was done using standard thickness gauge (Wallace, S4/14 00005), and the weight was determined using an analytical balance (ACU High precision balance, HJ-6004), as detailed in Table 11. Aluminum hydroxide-modified NRL balloons were approximately 13.9% heavier than Hevea CL60. The thickness profile also showing that the aluminum hydroxide-modified NRL CL60 is 18.3% thicker than common Hevea CL60. At the same solids content, the aluminum hydroxide-modified NRL CL60 balloon compounds were found to produce thicker balloons due to the high pick up of latex during dipping. The helium molecules being lighter and smaller are able to permeate out faster than normal air molecules of nitrogen and oxygen. This suggests that the dipping times can be reduced to achieve the same weight parameters.

A study was performed to analyze the gel time of balloon compounds made from aluminum hydroxide-modified NRL CL60 against common hevea CL60. The gel rate of aluminum hydroxide-modified NRL found to be low due to absence of the proteins and non-rubber impurities. These non-rubbers increase the stability of latex during film formation of latex hence increase the gelling rate of latex compounds.

Balloon PV compounds made as discussed above were used in the study. Balloon formers were dipped into 16% coagulant and dried in an oven for about 2 minutes at approximately 70° C. Later, the coagulant dipped formers were dipped into the latex compounds made from Aluminum hydroxide-modified NRL CL60 with 8 seconds dwell time. As soon as withdrawal from latex, the gelling time in air was checked. The surface of the latex was touched to check the film gelling. The time was recorded/stopped when there's no pick up of latex in the finger. At this point, latex has gelled and will not stick in fingers. Three tests were conducted for each compounds (Aluminum hydroxide-modified NRL CL60 and common Hevea CL60). The results are shown in Table 12.

Aluminum hydroxide-modified NRL compound demonstrated, on average, a gel time 7 seconds quicker than standard NRL. A reduced gel time (the interval of time required for a colloidal NRL solution to become a solid or semisolid jelly or gel) can translate into a reduction of drying temperature and time needed to set the adhesive; and a reduction in the time it takes for the adhesive to dry. This combination of reduced temperature and reduced drying time significantly reduces a manufacturer's manufacturing costs in terms of (i) energy required for heated temperatures and (ii) duration that is required before a manufacturer can move to another part of the manufacturing process, thereby increasing productivity in the same period of time for using aluminum hydroxide-modified NRL vs. standard NRL. The reduction in energy needed for aluminum hydroxide-modified NRL gel drying saves manufacturing costs and energy consumption—thereby saving money and improving the manufacturing efficiencies and lowering the drain on energy usage for the benefit of the community.

TABLE 12
Gel Time of Aluminum hydroxide-modified NRL vs Standard NRL

| Balloon PV | Gelling Time Reading (sec) | | | |
|---|---|---|---|---|
| Compound Sample Made From | 1 | 2 | 3 | Average |
| Aluminum hydroxide-modified NRL | 24.36 | 23.97 | 22.88 | 23.74 |
| Standard NRL | 31.65 | 30.86 | 30.17 | 30.89 |

In an embodiment, use of Aluminum hydroxide-modified NRL CL60 of the present disclosure in balloon compound applications and balloon dipping has the following benefits: less agitation for a homogenous latex compound and pigment mixture; less addition of pigment for a better color intensity and tone; less addition of whiting agents to increase the opacity and white index; better Helium and air retention of balloons; more pick-up of latex during dipping at the same solids content; less energy usage by reduction drying and leaching time or temperature due to faster gelling time; less drying time and temperature as less non-rubber content (impurities) can increase the specific heat capacity; and less (or in some applications no leaching) time and temperature as less non-rubber content (antigenic proteins) to be leached.

There are several processing steps that a dipped goods manufacturer currently goes through to produce a latex finished article, including, but not limited to, post leaching processes used to remove residual proteins from latex articles. In an embodiment, using an aluminum hydroxide-modified NRL of the present disclosure manufacturers can achieve savings in energy and material costs when using the aluminum hydroxide-modified NRL of the present disclosure because some of the processing steps typically required with NRL can be avoided or reduced in time using the aluminum hydroxide-modified NRL. Further, decreased pigmenting is an added cost benefit for such dipped good industries as breather bags and rubber tubings. Table 13 summarizes some of the potential impacts of using aluminum hydroxide-modified NRL on manufacturer costs.

TABLE 13
Potential Impact of using Modified NRL on Manufacturer Cost Structure

| | | | |
|---|---|---|---|
| Gloves | Adhesives | Foam | Balloons |

Raw Material

| | | | | |
|---|---|---|---|---|
| NRL/Synthetic | [symbol] | [symbol] | [symbol] | [symbol] |
| Aluminum hydroxide-modified | ↑ | ↑ | ↑ | ↑ |
| NRL | | | | |

Additives

| | | | | |
|---|---|---|---|---|
| Compounding Chemicals | ↓ | | ↓ | ↓ |
| Pigmenting Chemicals | | | | ↓ |
| Other Raw Materials (Acrylics | | [symbol] | | |
| etc.) | | | | |

Production:

| | | | | |
|---|---|---|---|---|
| Dipping | [symbol] | | | ↓ |
| Foaming/Blowing | | | [symbol] | |
| Spraying | | ↓ | | |

Production: Finishing Steps

| | | | | |
|---|---|---|---|---|
| Rinsing/leaching | [symbol] | | [symbol] | [symbol] |
| Drying | [symbol] | | [symbol] | [symbol] |
| Rinsing/leaching | ↓ | | ↓ | ↓ |
| Drying | | | | |
| Rinsing/leaching | ↓ | | ↓ | ↓ |
| Drying | | | | |
| Packaging | [symbol] | [symbol] | [symbol] | [symbol] |

[symbol]

No impact on cost of this step as a result of using aluminum hydroxide-modified NRL
↑ Aluminum hydroxide-modified NRL cost is higher than alternative ingredient
↓ Use of aluminum hydroxide-modified NRL reduces cost of this step

In an embodiment, an aluminum hydroxide-modified NRL of the present disclosure is used to manufacture thread. In an embodiment, a method of manufacturing thread from an aluminum hydroxide-modified NRL of the present disclosure includes streaming uncoagulated fluid aluminum hydroxide-modified NRL through a small-aperture nozzle or capillary into a bath of coagulant, e.g., acetic acid, washing the coagulated thread in a water bath, and drying and heat-curing the final product. In an embodiment, a method of manufacturing thread from an aluminum hydroxide-modified NRL of the present disclosure includes pumping the aluminum hydroxide-modified NRL through a spinneret immersed in a bath of sulfuric acid; extruding and coagulating the aluminum hydroxide-modified NRL in a form of a splitable tape; withdrawing the tape from the bath with a godet roll; stretching the tape to about 2 to about 10 times its length at rest to orient isoprene polymers so as to form a functional thread; drying the thread; splitting the thread using a coverer into individual ends and covers. In an embodiment, the aluminum hydroxide-modified NRL is pumped through a spinneret immersed in a bath of sulfuric acid, wherein the bath has a pH of about 1 to about 7. In an embodiment, the aluminum hydroxide-modified NRL is pumped through a spinneret immersed in a bath of sulfuric acid, wherein the bath has a pH of about 2 to about 5. In an embodiment, the aluminum hydroxide-modified NRL is pumped through a spinneret immersed in a bath of sulfuric acid, wherein the bath has a pH of about 3. In an embodiment, the acid bath is continuously replenished as it is consumed as the aluminum hydroxide-modified NRL is coagulated. In an embodiment, the aluminum hydroxide-modified NRL is extruded and coagulated in a form of a splitable tape of eight strands of from about 10 to about 300 gauge each. In an embodiment, the aluminum hydroxide-modified NRL is extruded and coagulated in a form of a splitable tape of eight strands of about 100 gauge each. In an embodiment, the drying tape is placed in a box and dusted with talc to keep it from sticking together. In an embodiment, the tape is split using a hollow spindle apparatus. In an embodiment, the yarn is double covered in S and Z directions. The yarn can then be sent to the end product manufacturer, or knitter, to make the end product clothing item. In an embodiment, prior to pumping the aluminum hydroxide-modified NRL through a spinneret, the aluminum hydroxide-modified NRL is compounded, colored and filled according to a spinners' specifications.

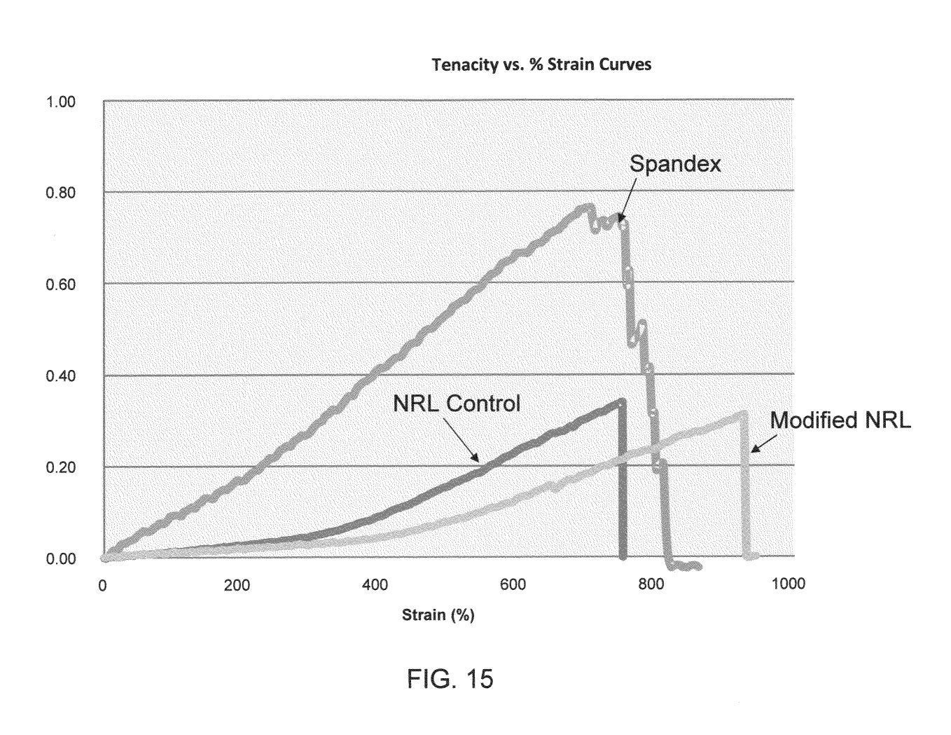

In an embodiment, use of an aluminum hydroxide-modified NRL of the present disclosure in elastic thread applications has benefits including, but not limited to, reduced molecular friction which appears to cause lower tenacity versus % strain curve compared to regular natural latex, see FIG. 15 (apparel made with such threads should be comfortable to don without undue compression, may retain fiber memory better over the life of the garment than spandex or even traditional latex); reduces employee and consumer exposure to latex allergens; natural, renewable, biodegradable, no volatile organic compounds (VOCs) or known human carcinogens, achieves compliance with corporate sustainability objectives and “green initiatives”). FIG. 15 shows the stress/strain curves for NRL, Spandex, and aluminum hydroxide-modified NRL of the present disclosure overlaid after the stress has been normalized against linear density to obtain “tenacity”. Physical property tests (see Table 14) of aluminum hydroxide-modified NRL threads of the present disclosure compared with NRL and Spandex threads reveals the aluminum hydroxide-modified NRL threads of the present disclosure have the elasticity desired in making certain types of clothing comfortable and easy to don. Aluminum hydroxide-modified NRL threads of the present disclosure stretch easily, even better than NRL, making it excellent for various types of clothing and hosiery that clings to the body. Aluminum hydroxide-modified NRL threads of the present disclosure can provide a more considerable hold. It is possible that the amount of ‘control’ may be controllable based on design versus inherent property of the aluminum hydroxide-modified NRL thread. Aluminum hydroxide-modified NRL threads of the present disclosure have the durable elasticity benefits of natural latex, but will stretch further before breaking and have a lower initial tensile modulus (a measure of the stiffness of a material) than either Spandex or traditional NRL. For the samples listed in Table 14, Filament Denier from short lengths of ˜1 meter was performed using the ASTM D1059 standard (Length measured with filaments under no tension); Yarn Tensile Properties was performed using the ASTM D2256 standard (Test Speed: 500 mm/min; Gauge Length: 2 inch); Moisture Content was performed using the ASTM D629—Section 9 standard (Equipment used: CEM Smart System 5—Microwave Moisture/Solid Analizer); and Density Estimate was performed using Volume Displacement (Tape specimens were weighed and placed into a 10-mL graduated cylinder (graduated to 0.1 mL) containing 5 mL of distilled water. A stirring rod was used to displace as many air bubbles as possible, and the final volume (volume of water plus tape specimen) was read).

TABLE 14
Physical Property Tests and Moisture Content & Density Results of Aluminum
Hydroxide-Modified NRL Threads of the Present Disclosure

| | Aluminum hydroxide- | | |
|---|---|---|---|
| Thread Test Results | modified NRL Threads | Traditional NRL | Spandex |
| Filament Denier | 453 ± 10 SD | 667 ± 9 SD | 141 ± 3 SD |
| Filament Diameter | 0.3246 ± 0.0079 | 0.2732 ± 0.0127 | 0.1433 ± 0.0050 |
| (mm) | | | |
| Peak Load (g) | 142.51 ± 10.64 SD | 220.12 ± 12.03 SD | 121.91 ± 10.24 SD |
| Elongation at Peak | 472.2 ± 24.8 SD | 391.8 ± 45.8 SD | 383.9 ± 81.3 SD |
| (mm) | | | |
| % Strain | 929.5 ± 48.8 SD | 771.3 ± 90.1 SD | 755.7 ± 160.1 SD |
| Energy to Peak (kg-mm) | 22.29 ± 1.98 | 30.39 ± 4.68 | 22.73 ± 5.79 |
| Modulus (g/denier) | 0.0088 ± 0.0007 SD | 0.0144 ± 0.0016 SD | 0.0781 ± 0.0111 SD |
| Tenacity (g/dener) | 0.31 ± 0.02 SD | 0.33 ± 0.02 SD | 0.87 ± 0.07 SD |
| Moisture Content (%) | 0.62 | 0.44 | NA |
| Moisture Regain (%) | 0.62 | 0.45 | NA |
| Density Estimate | 1.03 | 1.01 | NA |
| (g/cm³) | | | |
| Antigenic Protein | 3.8 | 14.1 | NA |
| (ELISA) μg/dm² | | | |
| Total Extractable | <95 | <269 | NA |
| Protein (Modified | | | |
| Lowry) μg/dm² | | | |

Denier measurements: Spandex is the most consistent with a Standard Deviation (SD) of 3 whereas NRL and aluminum hydroxide-modified NRL threads of the present disclosure are similar to each other with SDs of 9 and 10 respectively. This is expected as spandex is melt spun and the rubbers are wet spun. Melt spinning is easier to control.
Peak Load: This is the maximum load at the point of breaking. It does not reflect differences in yarn size. The tenacity measurement does adjust for size to allow for comparison. This can be considered a measurement of comfort and durability. NRL and aluminum hydroxide-modified NRL threads of the present disclosure are equal and Spandex is stronger, but less ‘comfortable’.
Elongation: This measures the length of fiber extension at breaking point. Strain is the percent elongation for comparison. Aluminum hydroxide-modified NRL threads of the present disclosure stretch more than NRL or Spandex. Hosiery or socks made with aluminum hydroxide-modified NRL threads of the present disclosure would be easier to don than Spandex.
Strain: Is the elongation as a percentage, which allows for comparison among the samples.
Energy to Peak: is the area under the stress/strain curve. Spandex and aluminum hydroxide-modified NRL threads of the present disclosure perform the best and are essentially equal. NRL takes more energy to move to peak load.
Modulus: This is the initial modulus or effort required to “get it moving” or stiffness. Spandex is a very stiff elastomer. An aluminum hydroxide-modified NRL thread of the present disclosure has a lower initial modulus as compared with Spandex.
Tenacity: is a equivocation of peak load for comparisons sake. Spandex is very strong, which limits its use due to lack of comfort. NRL and aluminum hydroxide-modified NRL threads of the present disclosure are better and equal.

In an embodiment, the present disclosure provides methods of modifying natural rubber latex. In an embodiment, the aluminum hydroxide-modified natural rubber latex is sufficiently designed to enhance the attributes and performance of articles manufactured from the aluminum hydroxide-modified natural rubber latex. In an embodiment, a slurry of aluminum hydroxide can be added to field latex. In such an embodiment, proteins and other non-rubber impurities present in the field latex can be exchanged with and/or complexed with insoluble aluminum hydroxide Al(OH)₃. In an embodiment, at least a portion of the proteins and/or non-rubber impurities can be adsorbed on a reactive surface of aluminum hydroxide crystals from the slurry, thus eliminating a significant portion of proteins and other non-rubber impurities in latex.

In an embodiment, an aluminum hydroxide-modified NRL of the present disclosure can be used to fabricate articles including, but not limited to, foam latex products (e.g., bedding components), latex adhesive products (e.g., medical bandages), dipped latex products (e.g., gloves, finger cots, sleeves, toy balloons and medical grade balloons), pigmented latex products (e.g., gloves, finger cots, sleeves, toy balloons and medical grade balloons) and elastic threads (e.g., hosiery (stockings, socks), athletic apparel (leggings, swimsuits, sports bras, compression socks), foundation garments (underwear bands, bra straps), apparel (elastic waistbands, wristbands), textiles (stretch fabric for garments, upholstery and in shoes) and for braided (“bungee”) cord). The aluminum hydroxide-modified NRL products fabricated from the aluminum hydroxide-modified NRL of the present disclosure are sufficiently designed to provide a number of benefits over raw NRL products, including, but not limited to, increased stability, longer shelf life, cleaner, whiter appearance, odorless, superior gas and air retention, heavier pick up during the dipping process, and a reduced gel time translating into a reduction of drying time and temperature. The overall performance benefits and attributes of using aluminum hydroxide-modified NRL offer a unique value proposition to manufacturers allowing them to capitalize on the “green” movement while addressing health and safety concerns.

In an embodiment, an aluminum hydroxide-modified natural rubber latex of the present disclosure is used in the fabrication of foam products, adhesive products, balloon products, pigmented products and dipped latex products. In an embodiment, a method of manufacturing an aluminum-hydroxide modified natural rubber latex of the present disclosure results in an aluminum hydroxide-modified natural rubber latex sufficiently designed to exhibit a whiter more transparent color as compared with an un-modified natural rubber latex. In an embodiment, a method of manufacturing an aluminum hydroxide-modified natural rubber latex of the present disclosure results in an aluminum hydroxide-modified natural rubber latex sufficiently designed to be odorless as compared with an un-modified natural rubber latex. In an embodiment, a method of manufacturing an aluminum hydroxide-modified natural rubber latex of the present disclosure results in an aluminum hydroxide-modified natural rubber latex sufficiently designed to have improved stability compared with an un-modified natural rubber latex. In an embodiment, a method of manufacturing an aluminum hydroxide-modified natural rubber latex of the present disclosure results in an aluminum hydroxide-modified natural rubber latex sufficiently designed to comprise reduced protein levels as compared with an un-modified natural rubber latex. In an embodiment, a method of manufacturing an aluminum hydroxide-modified natural rubber latex of the present disclosure results in an aluminum hydroxide-modified natural rubber latex sufficiently designed to comprise reduced non-rubber impurity levels as compared with an un-modified natural rubber latex. In an embodiment, a method of manufacturing an aluminum hydroxide-modified natural rubber latex of the present disclosure results in an aluminum hydroxide-modified natural rubber latex sufficiently designed to have a tighter rubber particle integration as compared with an un-modified natural rubber latex.

In an embodiment, a method of increasing transparency of natural latex rubber includes subjecting the natural latex rubber, prior to its vulcanization, to aluminum hydroxide to reduce carotenoid pigments in the natural latex rubber. In an embodiment, a method of reducing odor of natural latex rubber includes subjecting the natural latex rubber, prior to its vulcanization, to aluminum hydroxide to reduce non-rubber impurities in the natural latex rubber.

In an embodiment, a method of manufacturing aluminum hydroxide-modified natural rubber latex includes admixing aluminum hydroxide particles with latex from a rubber tree to form a slurry; adsorbing non-rubber components present in the latex onto a surface of the aluminum hydroxide particles; removing the aluminum hydroxide particles with adsorbed non-rubber components from the slurry; and creating a composition of modified natural rubber latex. In an embodiment, the non-rubber components removed from the latex include proteins, lutoids and carotenoids. In an embodiment, the method uses natural chemistry to treat NRL and results in aluminum hydroxide-modified NRL that remains 100% natural, is biodegradable and renewable. In an embodiment, the aluminum hydroxide method removes proteins and other non-rubber impurities from NRL, resulting in modified or treated NRL comprising significantly fewer allergenic and total proteins as well as improved physical and mechanical properties suitable for manufacturing processes. With a significantly reduced antigenic protein content, aluminum hydroxide-modified NRL of the present disclosure can eliminate the need for added processing steps to lower protein levels, saving energy, water, supply, and material handling costs while enhancing quality of the end product. The benefits in removing specific non-rubber molecules from NRL often leads to more stable, cleaner latex and can require less compounding additives for production. In an embodiment, aluminum hydroxide treated NRL is all natural, biodegradable and renewable, comprises no VOCs, is free of known or suspected carcinogens and non-toxic.

In an embodiment, a method of manufacturing an aluminum hydroxide-modified natural rubber latex of the present disclosure results in an aluminum hydroxide-modified natural rubber latex sufficiently designed to exhibit a whiter more transparent color as compared with an un-modified natural rubber latex. In an embodiment, a method of manufacturing an aluminum hydroxide-modified natural rubber latex of the present disclosure results in an aluminum hydroxide-modified natural rubber latex sufficiently designed to be less odorous as compared with an un-modified natural rubber latex. In an embodiment, a method of manufacturing an aluminum hydroxide-modified natural rubber latex of the present disclosure results in an aluminum hydroxide-modified natural rubber latex sufficiently designed to have improved stability compared with an un-modified natural rubber latex. In an embodiment, a method of manufacturing an aluminum hydroxide-modified natural rubber latex of the present disclosure results in an aluminum hydroxide-modified natural rubber latex sufficiently designed to comprise reduced protein levels as compared with an un-modified natural rubber latex. In an embodiment, a method of manufacturing an aluminum hydroxide-modified natural rubber latex of the present disclosure results in an aluminum hydroxide-modified natural rubber latex sufficiently designed to comprise reduced non-rubber impurity levels as compared with an un-modified natural rubber latex. In an embodiment, a method of manufacturing an aluminum hydroxide-modified natural rubber latex of the present disclosure results in an aluminum hydroxide-modified natural rubber latex sufficiently designed to have a tighter rubber particle integration as compared with an un-modified natural rubber latex.

In an embodiment, a pigment is added to an aluminum hydroxide-modified natural rubber latex of the present disclosure for the manufacture of a pigmented article. In an embodiment, an amount of pigment required to color an aluminum hydroxide-modified natural rubber latex of the present disclosure is less than an amount of pigment required to color a similarly sized un-modified natural rubber latex. In an embodiment, a foam product is manufactured from an aluminum hydroxide-modified natural rubber latex of the present disclosure and can require less fragrance than untreated NRL. In an embodiment, an adhesive is manufactured from an aluminum hydroxide-modified natural rubber latex of the present disclosure. In an embodiment, a latex balloon is manufactured from an aluminum hydroxide-modified natural rubber latex of the present disclosure. In an embodiment, the latex balloon can retain air better than a similarly sized latex balloon manufactured from un-modified natural rubber latex. In an embodiment, the latex balloon can retain helium better than a similarly sized latex balloon manufactured from un-modified natural rubber latex. In an embodiment, the latex balloon has a greater thickness than a similarly sized latex balloon manufactured from un-modified natural rubber latex.

All patents, patent applications, and published references cited herein are hereby incorporated by reference in their entirety. It will be appreciated that several of the above-disclosed and other features and functions, or alternatives thereof, may be desirably combined into many other different systems or application. Various presently unforeseen or unanticipated alternatives, modifications, variations, or improvements therein may be subsequently made by those skilled in the art.

What is claimed is:

1. An inflatable latex balloon comprising an aluminum hydroxide-modified natural rubber latex envelope.

2. The inflatable latex balloon of claim 1 wherein the aluminum hydroxide-modified natural rubber latex envelope is substantially free of non-rubber impurities.

3. The inflatable latex balloon of claim 1 wherein the aluminum hydroxide-modified natural rubber latex envelope has less than 0.5% non-rubber impurities.

4. The inflatable latex balloon of claim 2 wherein the aluminum hydroxide-modified natural rubber latex envelope is substantially free of non-rubber impurities selected from at least one of Frey-Wyssling particles or lutoids.

5. The inflatable latex balloon of claim 1 wherein the aluminum hydroxide-modified natural rubber latex envelope has decreased permeability to inflation gasses such as helium and air as compared with an inflatable latex balloon comprising a natural rubber latex envelope.

6. The inflatable latex balloon of claim 1 wherein the aluminum hydroxide-modified natural rubber latex envelope has increased inflation time to inflation gasses such as helium and air as compared with an inflatable latex balloon comprising a natural rubber latex envelope.

7. The inflatable latex balloon of claim 1 wherein the aluminum hydroxide-modified natural rubber latex envelope has a higher opacity as compared with an inflatable latex balloon comprising a natural rubber latex envelope.

8. The inflatable latex balloon of claim 1 wherein the aluminum hydroxide-modified natural rubber latex is pigmented with a color.

9. The inflatable latex balloon of claim 1 for toy applications.

10. An inflatable latex balloon made by the steps of:
subjecting natural rubber latex liquid, prior to its vulcanization, to an amount of aluminum hydroxide sufficient to adsorb non-rubber impurities in the natural rubber latex liquid to the aluminum hydroxide to create a suspension;
centrifuging the suspension, wherein the adsorbed non-rubber impurities are separated from the natural rubber latex liquid to result in a supernatant solution of aluminum hydroxide-modified natural rubber latex;
removing the supernatant solution of aluminum hydroxide-modified natural rubber latex; and
dipping a mold shaped like a deflated balloon into the supernatant solution of aluminum hydroxide-modified natural rubber latex to form the inflatable latex balloon.

11. The inflatable latex balloon of claim 10 further comprising prior to the dipping step:
adding a pigment into the supernatant solution of aluminum hydroxide-modified natural rubber latex.

12. The inflatable latex balloon of claim 10 further comprising after the dipping step:
forming a lip on a neck of the balloon; and
drying the supernatant solution of aluminum hydroxide-modified natural rubber latex on the mold.

13. The inflatable latex balloon of claim 10 wherein the amount of aluminum hydroxide sufficient to adsorb non-rubber impurities to the aluminum hydroxide is from about 0.01 pounds per hundred pounds of rubber to about 5 pounds per hundred pounds of rubber.

14. The inflatable latex balloon of claim 10 wherein the centrifuging and removing steps are performed more than once.

15. An extruded rubber thread comprising an aluminum hydroxide-modified natural rubber latex.

16. The extruded rubber thread of claim 15 wherein the aluminum hydroxide-modified natural rubber latex is substantially free of non-rubber impurities.

17. The extruded rubber thread of claim 15 wherein the aluminum hydroxide-modified natural rubber latex has less than 0.5% non-rubber impurities.

18. The extruded rubber thread of claim 15 wherein the aluminum hydroxide-modified natural rubber latex has a lower initial tensile modulus as compared with an extruded rubber thread comprising a natural rubber latex.

19. The extruded rubber thread of claim 15 wherein the aluminum hydroxide-modified natural rubber latex has increased stretch before breaking as compared with an extruded rubber thread comprising a natural rubber latex.

20. The extruded rubber thread of claim 15 for textile, medical, scientific, sports and food processing applications.

21. A latex foam article comprising an aluminum hydroxide-modified natural rubber latex.

22. The latex foam article of claim 21 wherein the aluminum hydroxide-modified natural rubber latex is substantially free of non-rubber impurities.

23. The latex foam article of claim 21 wherein the aluminum hydroxide-modified natural rubber latex has less than 0.5% non-rubber impurities.

24. The latex foam article of claim 22 wherein the aluminum hydroxide-modified natural rubber latex envelope is substantially free of non-rubber impurities selected from at least one of Frey-Wyssling particles or lutoids.

25. The latex foam article of claim 21 wherein the aluminum hydroxide-modified natural rubber latex has decreased odor as compared with a latex foam article comprising natural rubber latex.

26. The latex foam article of claim 21, wherein the foam article is selected from the group consisting of mattresses, pillows and cushions.
